(19) United States
(12) Patent Application Publication
(10) Pub. No.: US 2011/0228658 A1
(43) Pub. Date: Sep. 22, 2011

(54) INFORMATION RECORDING METHOD, OPTICAL INFORMATION RECORDING/REPRODUCING DEVICE, AND OPTICAL INFORMATION RECORDING MEDIUM USED FOR THE SAME

(76) Inventors: Atsushi Nakamura, Osaka (JP); Shigeru Furumiya, Hyogo (JP)

(21) Appl. No.: 12/599,066

(22) PCT Filed: Apr. 28, 2008
(86) PCT No.: PCT/JP2008/001116

§ 371 Date: Nov. 6, 2009

(30) Foreign Application Priority Data
May 8, 2007 (JP) 2007-123186

(51) Int. Cl. G11B 7/12; G11B 20/10

(52) U.S. Cl. 369/47.19; 369/47.53; G9B/7.101; G9B/20.009

(57) ABSTRACT

An optical information recording reproducing apparatus precisely decides at least the time width of a recording pulse sequence so as to obtain a preferable signal quality by controlling a recording power and a pulse time width during a high-speed write. The apparatus includes: modulation instrument for generating a test pattern containing at least a first recording mark length; recording pulse sequence conversion instrument for converting the test pattern into a recording pulse sequence containing test recording pulses having different time widths corresponding to at least the first recording mark length; beam irradiation instrument; reproduced signal processing instrument for holding as a first signal index characteristic, the relation between a first signal index acquired according to the reproduced signal obtained from a predetermined area and the recording power; and recording condition calculation instrument for obtaining a desired time width of a recording pulse of the first recording mark length.

### CROSS-REFERENCE TO RELATED APPLICATIONS

This application is a U.S. national phase application of PCT International Patent Application No. PCT/JP2008/001116 filed on Apr. 28, 2008, claiming the benefit of priority of Japanese Patent Application No. 2007-123186 filed on May 8, 2007, all of which are incorporated by reference herein in their entirety.

### TECHNICAL FIELD

The present invention relates to an information recording method, an optical disc recording and reproducing apparatus, and an optical disc medium, which records information by irradiating a laser light to an optical disc to form marks of which physical characteristics is different from non-recorded portion. The present invention relates in particular to an information recording method, an optical information recording and reproducing apparatus, and an optical information recording medium to be used therefore or the like, which records information on recordable optical disc medium called “BD-R” at high speed.

### BACKGROUND ART

The optical memory technology with an optical disc having the pit-like shaped pattern as a high density and large capacity storage medium has been put to practical use, while the use of the optical memory technology has been expanded in Blu-ray Disc (BD), Digital Versatile Disk (DVD), Video Disc, Document file Disc and Data file Disc. The request of the technology rises in particular in the market of the recordable optical disc which is called write-once Disc such as DVD-R, BD-R and so on. It is disclosed at Japanese Patent Laid-Open No. 2004-362748 that material containing Te—O—M (Here, M is at least one element chosen among a metallic element, a semimetals element and a semiconductor element.) were used as an example of the recording material of the write-once optical disc. That is, the recording material is material containing Te, O and M and is composite material that the fine particles of Te, Te—M and M are dispersed uniformly at random in a matrix of TeO₂ just after deposition. When the film formed by this recording material is irradiated with a laser light, the film is melted and the crystal of Te or Te—M with large particle size is separated. The difference of the optical condition of the film under this situation can be detected as a signal, thereby a record admit a write-once, what is called write-once record, is enabled.

The method of optimizing the laser power for irradiating to a recordable optical disc and the method of optimizing the write-strategy are disclosed by Japanese Patent Laid-Open No. 2003-173560 and Japanese Patent Laid-Open No. 2000-251254. On these methods disclosed by these documents, the information of the write-strategy in which a recommended recording power or an optical waveform for writing is described is recorded in an initial value recording area of the optical recording disc. The optical disc apparatus is able to learn the power for recording at arbitrary timing with the initial value information as a clue.

Particularly, in recent years, the recording at the high-speed transfer rate is strongly requested on the computer peripheral device and the optical disc recording apparatus, which supports large capacity optical disc. It is necessary that the number of times of rotation of the disc is rose to effect high-speed transfer rate, and it is necessary that the laser power at the recording is increased according to rising of the number of times of rotation of the disc. However, generally, with respect to the optical disc of which the phase-change between crystal and non-crystal of the recording film is occurred by the laser irradiation, the formed recording mark changes according as the linear velocity is speed up. In other words, there is a problem that jitter deteriorates, because lack of heat capacity is occurred depends on top of the heat pulses necessary for forming the recording mark, the mean length of the recording mark is varied depends on the difference of the heat temperature for reaching the most suitable decomposition temperature, or the increase and decrease part is caused in the width of the recording mark (in other word, “tears-shaped mark”) according to the length of the recording mark depends on it that the uniform width of the recording mark can not be obtained due to the difference of the duty ratio for suitable heating pulse. Therefore, it is necessary that the width of the recording pulse and recording power of the recording pulse is optimized according as the linear velocity speeds up.

Additionally, for recording at the high-speed transfer rate, the information is recorded to an optical disc by a CAV (Constant Angular Velocity) method replacing with a conventional CLV (Constant Linear Velocity) method. The method called CLV method is a method in which the speed of rotation of an optical disc is controlled so that the number of times of rotation is in inverse proportion to the radius of truck, and the linear velocity is kept to a constant, and the information is recorded on the optical disc by the frequency of the constant recording channel clock. At the case of the CAV method, the frequency of channel clock for recording to an optical disc is proportioned to the position of radius of the truck so that the frequency becomes low at the inner side and high at the outer side of the optical disc. The case of the CAV method, recording linear velocity is slow at the inner side and fast at the outer side, but the recording linear density is constant.

For example, when information is recorded at the high-speed transfer rate corresponding to 8X drive speed of BD by using the CLV method, the number of times of rotation of the spindle motor will exceed 10,000 rpm that is the critical number of times of rotation for practical use decided based on breaking limit of plastics as the substrate material with due regard to safety. The other side, when information is recorded at the maximum number of times of rotation 10,000 rpm by using the CAV method, the high-speed transfer rate is obtained, that is the high-speed transfer rate is 5X drive speed of BD at the innermost side and 12X drive speed of BD at the outermost side. By the CAV method, an effect to be able to use small and low-cost motor is obtained because the rotation speed control of a spindle motor controlling the rotation of an optical disc is unnecessary. Moreover, the access time will be largely shortened because the rotation speed is not changed, and the waiting time for changing speed at the seek operation is unnecessary. However, since the linear velocity is changed gradually from the inner side to the outer side of the optical disc, it is necessary to optimize the recording pulse sequence or the recording power according to the changing linear velocity appropriately.

About solutions for these problems, there are disclosures to Japanese Patent Laid-Open No. Hei 5-274678, International Publication Brochure No. 03/107332, and Japanese Patent Laid-Open No. Hei 5-225570. The Japanese Patent Laid-Open No. Hei 5-274678 discloses a method in which information is recorded to the outer side area with higher frequency than the inner side area by irradiating an optical beam modulated intensity thereof according to the write-strategy based on the standard clock differed depending on the recording area position while rotating the optical disc with the number of times of rotation constant, for decreasing the laser power for recording without a jitter characteristics turning worse. That is, in this method, the optical beam which emits the light in the shape of a pulse periodically according to the frequency of integral multiple of the frequency of the standard clock is used while changing the linear velocity at each of the area of the optical beam, and the duty of the emission as a pulse at the time of irradiating the optical beam to the outer side area is controlled bigger than the duty of the emission as a pulse luminescent at the time of irradiating the optical beam to the inner side area. And International Publication Brochure No. 03/107332 discloses a method in which the thermal distortion of the mark as a time of recording is solved and the pulse width of the recording pulse sequence and the recording power are optimized for each of the linear velocities by shifting the positions of the top pulse and the last pulse of the recording pulse sequence. And in Japanese Patent Laid-Open No. Hei 5-225570, for finding the optimum recording powers about all of the recordable area of individual optical disc in a short time relatively, a method in which the optimum quantities of light for all of the linear velocities are found by using the following procedure is disclosed. The procedure is that the optimum recording powers for each of the linear velocities at least two positions in the test recording area are found by using the interpolation routine and the interpolation or the extrapolation is performed about the found optimum recording powers for the two linear velocities.

The entire disclosure of the following patent document is incorporated herein by reference in its entirety.

### DISCLOSURE OF THE INVENTION

### Problems to be Solved by the Invention

First of all, when the phase-change optical disc, like recordable optical disc medium like BD-R, on which a recording mark is formed depending on the irradiation calories from the laser light is written with high-speed, the channel clock frequency grows big. Therefore the time width of the pulse of the laser light which is modulated in pulse-like shaped is short, and the effect of rising time and trailing time of the laser for recording is big, then it becomes difficult to control the time width of the recording pulse sequence. Affects of an overshoot and an undershoot before it settled down to a set steady state is big because the change time for laser power at recording is fast, then it becomes difficult to control the recording power precisely. That is, there is a problem that it is difficult to maintain good recording signal quality by controlling the width of recording pulse and recording power precisely.

And there is a test recording area at the part of the inner side but there is not a test recording area at the part of the outer side of an optical disc. When such an optical disc is recorded by the CAV method, the number of times of rotation at the inner side is same as it of the outer side, but the linear velocity at the outer side is the linear velocity 2.4 times faster than the linear velocity of the inner side. Such the case, there is a problem. That is, the recording power and the width of the recording pulse can be learned at the slowly linear velocity at the inner side, but the recording power and the width of the recording pulse can not be optimized at the fast linear velocity at the outer side.

In consideration of the problems of the conventional information recording method, an object of the present invention is to provide an information recording method in which the optimum time width of the recording pulse can be decided precisely than conventional method at least as well as to provide an optical information recording and reproducing apparatus, and an optical information recording medium to be used therefore, program and storage media.

Moreover, in consideration of the problems of the conventional information recording method, an object of the present invention is to provide an information recording method in which the optimum time width of the recording pulse can be decided precisely than conventional method at least for recording a signal to an optical disc at the high-speed transfer rate such as exceed 4X drive speed of BD (channel clock is 264 MHz) as well as to provide an optical information recording and reproducing apparatus, and an optical information recording medium to be used therefore, program and storage media.

### Means for Solving the Problems

The 1^{st} aspect of the present invention is an information recording method of recording information on an optical information recording medium utilizing a desired recording power of a laser light and a desired time width of recording pulse, said information recording method comprising:

a test pattern generating step of generating a test pattern including a first recording mark length and a second recording mark length which is longer than said first recording mark length;

a recording pulse sequence converting step of converting said generated test pattern into a recording pulse sequence including test recording pulses, said test recording pulses corresponding to said first recording mark length and having a different time width to each other and a second test recording pulse corresponding to said second record mark length;

a recording step of recording said test pattern on a predetermined area of said optical information recording medium based on said recording pulse sequence, with changing a recording power sequentially by controlling said laser light;

a reproducing step of obtaining a first signal index every said test recording pulse having a different time width based on a reproduced signal obtained from said predetermined area, said first signal index corresponding to each said changed recording power, and of holding a relation between said obtained first signal index and said recording power, as a first signal index characteristic, and obtaining a second signal index according to each said recording power based on a portion corresponding to said second test recording pulse of said reproduced signal and holding a relation between said obtained second signal index and said recording power, as a second signal index characteristic; and

a processing step of obtaining said desired recording power to be used for a recording pulse corresponding to said first recording mark length based on said second signal index characteristic, and obtaining said desired time width of recording pulse corresponding to said first recording mark length, based on a predetermined rule by using (a) obtained said desired recording power, (b) each target recording power obtained from said first signal index characteristic which is held every said test recording pulse having a different time width by using a recommended first signal index and (c) each said different time width.

The 3^{rd} aspect of the present invention is the information recording method according to the 1^{st} aspect of the present invention, wherein

said first signal index is asymmetry or β-value of said reproduced signal;

said second signal index is a modulation level of said reproduced signal; and

in said reproducing step, when said first signal index is obtained every said test recording pulse having a different time width, a reproduced signal of each said test recording pulse having a different time width and a reproduced signal of said second test recording pulse are used.

The 4^{th} aspect of the present invention is the information recording method according to the 1^{st} aspect of the present invention, wherein

said first signal index is a signal index which is obtained by using a reproduced signal level of said first recording mark length and a reproduced signal level of a reflected light at a non-recorded portion.

The 5^{th} aspect of the present invention is the information recording method according to the 1^{st} aspect of the present invention, wherein

when Tt1 and Tt2 represent respective widths of said test recording pulses having different time widths and Pwt1 and Pwt2 represent respective said target recording powers, in said processing step, constants C1 and C2 are obtained by using that a following formula 1 is approved.

Pwt=C1/Tt+C2 (wherein, C1 and C2 are constants) [Formula 1]

The 6^{th} aspect of the present invention is the information recording method according to the 5^{th} aspect of the present invention, wherein

said obtaining of said desired time width of recording pulse corresponding to said first recording mark length based on said predetermined rule means that Tto is obtained by using a following formula 5 when said Tto represents said desired time width and Pwo represents said desired recording power.

Tto=Tt1×Tt2×(Pwt1−Pwt2)/{Pwo×(Tt2−Tt1)−(Tt2×Pwt2−Tt1×Pwt1)} [Formula 5]

The 7^{th} aspect of the present invention is the information recording method according to the 1^{st} aspect of the present invention, wherein

said test pattern includes a repeat signal of a mark and a space to be formed by controlling an irradiation of said laser corresponding to said first recording mark length and a repeat signal of a mark and a space to be formed by controlling an irradiation of said laser corresponding to said second recording mark length.

The 8^{th} aspect of the present invention is the information recording method according to the 7^{th} aspect of the present invention, wherein

said first recording mark length is such recording mark length of a shortest length 2 T; and

said test pattern includes a repeat signal of a mark of 2 T and a space of 2 T and a repeat signal of a mark and a space, each of said mark and said space having at least one length of 5 T to 9 T for said second mark length.

The 9^{th} aspect of the present invention is the information recording method according to the 7^{th} aspect of the present invention, wherein

said first recording mark length is a recording mark length of 3 T when 3 T represents a recording mark length of a shortest length; and

said test pattern includes a repeat signal of a mark of 3 T and a space of 3 T and a repeat signal of a mark and a space, each of said mark and said space having at least one length of 6 T to 14 T for said second mark length.

The 10^{th} aspect of the present invention is the information recording method according to the 1^{st} aspect of the present invention, wherein

said test pattern is a random signal where frequency of occurrence of each said mark length is substantial constant.

The 11^{th} aspect of the present invention is the information recording method according to the 1^{st} aspect of the present invention, wherein

said test pattern is an arbitrary random signal modulated with a 17PP modulation or a 8-16 modulation.

The 12^{th} aspect of the present invention is the information recording method according to the 1^{st} aspect of the present invention, wherein

in said recording step, a plurality of said test patterns are continuously recorded while changing said recording power; and

in said reproducing step, said plurality of said test patterns are continuously reproduced.

The 13^{th} aspect of the present invention is the information recording method according to the 1^{st} aspect of the present invention, wherein

when Tw represents a reference time width, a time width of said first recording mark length is normalized by a unit of integral multiple of Tw/16.

The 14^{th} aspect of the present invention is an information recording method of recording information on an optical information recording medium with at least a first linear velocity Lv1, a second linear velocity Lv2 and a third linear velocity Lv3, said first, second and third linear velocities being different each other (wherein, Lv1<Lv2<Lv3), said information recording method comprising:

a step of obtaining values relating to at least normalized optimum recording pulse widths nv1 and nv2 at said first linear velocity Lv1 and said second linear velocity Lv2 as information corresponding to said desired time width, by using said information recording

a target recording power obtaining step of (a) obtaining a target recording power Pwt12 corresponding to said value relating to said normalized optimum recording pulse width nv2 by using a predetermined relation between a target recording power Pwt and a time width Tt of said recording pulse, at said first linear velocity Lv1, when said value relating to said normalized optimum recording pulse width nv2 is equal to or more than a predetermined reference value, and (b) obtaining a target recording power Pwt13 corresponding to a value relating to a normalized optimum recording pulse width nv3 at said third linear velocity by using a predetermined relation between a target recording power Pwt and a time width Tt of said recording pulse, at said first linear velocity Lv1 and further obtaining a target recording power Pwt23 corresponding to a value relating to said optimum recording pulse width nv3 by using a relation between a target recording power Pwt and a time width Tt of said recording pulse, at said second linear velocity Lv2, when said value relating to said normalized optimum recording pulse width nv2 is less than said predetermined reference value; and

an optimum recording power obtaining step of obtaining an optimum recording power at said third linear velocity Lv3 by using said obtained target recording power.

The 15^{th} aspect of the present invention is the information recording method according to the 14^{th} aspect of the present invention, wherein

said time width Tt of said recording pulse is each time width Tt of test recording pulses which corresponds to said first recording mark length and has different time width to each other; and

said predetermined relation is a relation in which said each time width Tt of test recording pulses having different time width and a target recording power Pwt corresponding to said Tt satisfy a following formula 1.

Pwt=C1/Tt+C2 (wherein, C1 and C2 are constants) [Formula 1]

The 16^{th} aspect of the present invention is the information recording method according to the 14^{th} aspect of the present invention, wherein

when said normalized optimum recording pulse width nv2 is equal to or more than said predetermined reference value, said normalized optimum pulse width nv3 at said third linear velocity Lv3 is determined as an integer nv3 satisfying a condition of nv3=nv2>nv1.

The 17^{th} aspect of the present invention is the information recording method according to any one of the 14^{th} to 16^{th} present inventions, wherein

said optimum pulse width nv3 at said third linear velocity Lv3 satisfies a condition of Tw/16×nv3≧2[ns].

The 18^{th} aspect of the present invention is the information recording method according to any one of the 14^{th} to 17^{th} aspects of the present inventions, wherein

a channel clock to be used when recording by said third linear velocity Lv3 is 330 MHz or more.

The 19^{th} aspect of the present invention is an optical information recording medium which is used by the information recording method according to any one of the 1^{st} and 3^{rd} to 14^{th} aspects of the present inventions, wherein

recording of information on said optical information recording medium is performed by using a first linear velocity Lv1, a second linear velocity Lv2 and a third linear velocity Lv3 (wherein, Lv1<Lv2<Lv3); and

when Tt=n×Tw/16 (wherein, n is a positive integer) represents a recommended pulse time width of peak power level of said recording pulse sequence at the time of recording a shortest mark, n1 represents a recommended pulse width at said first linear velocity, n2 represents a recommended pulse width at said second linear velocity and n3 represents a recommended pulse width at said third linear velocity, values of said n1, n2 and n3 are recorded in a disc management area of said optical information recording medium beforehand.

The 20^{th} aspect of the present inventions is the optical information recording medium according to the 19^{th} aspect of the present invention, wherein

said three recommended pulse widths satisfy a condition of n1=n2=n3.

The 21^{st} aspect of the present invention is the optical information recording medium according to the 19^{th} aspect of the present invention, wherein

said three recommended pulse widths satisfy a condition of (n2/n1)=(n3/n2).

The 22^{nd} aspect of the present invention is the optical information recording medium according to the 19^{th} aspect of the present invention, wherein

said three recommended pulse widths satisfy a condition of n3=n2≧n1.

The 23^{rd} aspect of the present invention is the optical information recording medium according to the 19^{th} aspect of the present invention, wherein

a value n3 of said recommended pulse width of said third linear velocity satisfies a condition of Tw/16×n3≧2 [ns].

The 24^{th} aspect of the present invention is an optical information recording and reproducing apparatus which records information on an optical information recording medium utilizing a desired recording power of a laser light and a desired time width of recording pulse, said optical information recording and reproducing apparatus comprising:

a modulation unit which generates a test pattern including a first recording mark length and a second recording mark length which is longer than said first recording mark length;

a recording pulse sequence converting unit which converts said generated test pattern into a recording pulse sequence including test recording pulses, said test recording pulses corresponding to said first recording mark length and having a different time width to each other and a second test recording pulse corresponding to said second record mark length;

a light irradiation unit which records said test pattern on a predetermined area of said optical information recording medium based on said recording pulse sequence, with changing a recording power sequentially by controlling said laser light;

a reproduced signal processing unit which obtains a first signal index every said test recording pulse having different time width based on a reproduced signal obtained from said predetermined area, said first signal index corresponding to each said changed recording power, and holds a relation between said obtained first signal index and said recording power, as a first signal index characteristic, and obtains a second signal index according to each said recording power based on a portion corresponding to said second test recording pulse of said reproduced signal and holds a relation between said obtained second signal index and said recording power, as a second signal index characteristic; and

a recording condition obtaining unit which obtains said desired recording power to be used for a recording pulse corresponding to said first recording mark length based on said second signal index characteristic, and obtains said desired time width of recording pulse corresponding to said first recording mark length, based on a predetermined rule by using (a) obtained said desired recording power, (b) each target recording power obtained from said first signal index characteristic which is held every said test recording pulse having a different said time width by using a recommended first signal index and (c) each said different time width.

The 26^{th} aspect of the present invention is the optical information recording and reproducing apparatus according to the 24^{th} aspect of the present invention, wherein

said first signal index is asymmetry or β-value of said reproduced signal;

said second signal index is a modulation level of said reproduced signal; and

said reproduced signal processing unit uses a reproduced signal of each said test recording pulse having a different time width and a reproduced signal of said second test recording pulse when said first signal index is obtained every said test recording pulse having a different time width.

The 27^{th} aspect of the present invention is the optical information recording and reproducing apparatus according to the 24^{th} aspect of the present invention, wherein

said first signal index is a signal index which is obtained by using a reproduced signal level of said first recording mark length and a reproduced signal level of a reflected light at a non-recorded portion.

The 28^{th} aspect of the present invention is the optical information recording and reproducing apparatus according to the 24^{th} aspect of the present invention, wherein

when Tt1 and Tt2 represent respective widths of said test recording pulses having different time widths and Pwt1 and Pwt2 represent respective said target recording powers, said recording condition obtaining unit obtains constants C1 and C2 by using that a following formula 1 is approved.

Pwt=C1/Tt+C2 (wherein, C1 and C2 are constants) [Formula 1]

The 29^{th} aspect of the present invention is the optical information recording and reproducing apparatus according to the 28^{th} aspect of the present invention, wherein

said obtaining of said desired time width of recording pulse corresponding to said first recording mark length based on a predetermined rule means that Tto is obtained by using a following formula 5 when said Tto represents said desired time width and Pwo represents said desired recording power.

Tto=Tt1×Tt2×(Pwt1−Pwt2)/{Pwo×(Tt2−Tt1)−(Tt2×Pwt2−Tt1×Pwt1)} [Formula 5]

The 30^{th} aspect of the present invention is a program which causes a computer to execute, in the information recording method according to the 1^{st} aspect of the present invention,

said processing step of obtaining said desired recording power to be used for a recording pulse corresponding to said first recording mark length based on said second signal index characteristic, and obtaining said desired time width of recording pulse corresponding to said first recording mark length, based on a predetermined rule by using (a) obtained said desired recording power, (b) each target recording power obtained from said first signal index characteristic which is held every said test recording pulse having a different time width by using a recommended first signal index and (c) each said different time width.

The 31^{st} aspect of the present invention is a program which causes a computer to execute, in the information recording method according to the 14^{th} aspect of the present invention,

said target recording power obtaining step of (a) obtaining a target recording power Pwt12 corresponding to said value relating to said normalized optimum recording pulse width nv2 by using a predetermined relation between a target recording power at said first linear velocity Lv1 and a time width Tt of said recording pulse when said value relating to said normalized optimum recording pulse width nv2 is equal to or more than a predetermined reference value, and (b) obtaining a target recording power Pwt13 corresponding to a value relating to a normalized optimum recording pulse width nv3 at said third linear velocity by using a predetermined relation between a target recording power Pwt at said first linear velocity Lv1 and a time width Tt of said recording pulse and further obtaining a target recording power Pwt23 corresponding to a value relating to said optimum recording pulse width nv3 by using a relation between a target recording power at said second linear velocity Lv2 and said time width Tt of said recording pulse when said value relating to said normalized optimum recording pulse width nv2 is less than said predetermined reference value, and

to execute said optimum recording power obtaining step of obtaining an optimum recording power at said third linear velocity Lv3 by using said obtained target recording power.

The 32^{nd} aspect of the present invention is a recording medium which records the program according to the 30^{th} aspect of the present invention or the 31^{st} aspect of the present invention and can be processed by a computer.

The 33^{rd} aspect of the present invention is an information recording method of recording information on an optical information recording medium with at least a first linear velocity Lv1, a second linear velocity Lv2 and a third linear velocity Lv3, said first, second and third linear velocities being different each other (wherein, Lv1<Lv2<Lv3), said information recording method comprising:

a step of obtaining values relating to at least normalized optimum recording pulse widths nv1 and nv2 at said first linear velocity Lv1 and said second linear velocity Lv2 as a desired time width of recording pulse;

a target recording power obtaining step of (a) obtaining a target recording power Pwt12 corresponding to said value relating to said normalized optimum recording pulse width nv2 by using a predetermined relation between a target recording power Pwt and a time width Tt of said recording pulse, at said first linear velocity Lv1, when said value relating to said normalized optimum recording pulse width nv2 is equal to or more than a predetermined reference value, and (b) obtaining a target recording power Pwt13 corresponding to a value relating to a normalized optimum recording pulse width nv3 at said third linear velocity by using a predetermined relation between a target recording power Pwt and a time width Tt of said recording pulse, at said first linear velocity Lv1 and further obtaining a target recording power Pwt23 corresponding to a value relating to said optimum recording pulse width nv3 by using a relation between a target recording power Pwt and a time width Tt of said recording pulse, at said second linear velocity Lv2, when said value relating to said normalized optimum recording pulse width nv2 is less than said predetermined reference value; and

an optimum recording power obtaining step of obtaining an optimum recording power at said third linear velocity Lv3 by using said obtained target recording power.

### Advantage of the Invention

As described above, the present invention can provide an information recording method which can decide the optimum time width of the recording pulse precise than conventional method at least as well as to provide an optical information recording and reproducing apparatus, and an optical information recording medium, program and storage media.

Moreover, the present invention can provide an information recording method which can decide the optimum time width of the recording pulse precise than conventional method at least for recording an signal to an optical disc at the high-speed transfer rate such as exceed 4X drive speed of BD (channel clock is 264 MHz) as well as to provide an optical information recording and reproducing apparatus, and an optical information recording medium, program and storage media.

### BRIEF DESCRIPTION OF THE DRAWINGS

FIG. 1 is a diagram for describing a general configuration of an optical information recording and reproducing apparatus according to an embodiment of the present invention;

FIG. 2 is a diagram for describing the configuration of an optical information recording medium according to an embodiment of the present invention;

FIG. 3 is a diagram for describing a modulation signal and a recording pulse sequence according to an embodiment of the present invention;

FIG. 4 is a diagram for describing a measurement result of the recording power and the asymmetry of the reproduced signal with the recording pulse widths of four kinds according to an embodiment of the present invention;

FIG. 5 is a diagram for describing a relation between the target recording power Pwt and the reciprocal number of the normalized pulse width of the 2 T mark according to an embodiment of the present invention;

FIG. 6 is a diagram for describing a procedure for deciding the optimum recording power and the optimum time width of the recording pulse according to an embodiment of the present invention;

FIG. 7 is a diagram for describing notionally (typically) a recording block when a test pattern is recorded according to an embodiment of the present invention;

FIG. 8 is a diagram for describing a modulation signal and a reproduced signal from an optical pick-up according to an embodiment of the present invention;

FIG. 9 is a diagram for describing a measurement result the modulation level of the reproduced signal with the recording power according to an embodiment of the present invention;

FIG. 10 is a diagram for describing a measurement result the asymmetry of the reproduced signal with the recording power according to an embodiment of the present invention;

FIG. 11 is a diagram for describing a relation between the recording power and the product of the modulation level by the power according to an embodiment of the present invention;

FIG. 12(a) is a diagram for describing the β-value according to an embodiment of the present invention;

FIG. 12(b) is a diagram for describing the β-value according to an embodiment of the present invention;

FIG. 13 is a diagram for describing another example of a procedure for deciding the optimum recording power and the optimum time width of the recording pulse according to an embodiment of the present invention;

FIG. 14 is a diagram for describing another example of a recording pulse sequence according to an embodiment of the present invention;

FIG. 15 is a diagram for describing a relation between the target recording power and the reciprocal number (1/nv) of the normalized pulse width when recording is performed at different three linear velocities according to an embodiment of the present invention;

FIG. 16 is a diagram for describing a relation between the target recording power and the reciprocal number (1/nv) of the normalized pulse width when recording is performed at different three linear velocities according to an embodiment of the present invention; and

FIG. 17 is a diagram for describing a procedure for deciding the optimum recording power and the optimum time width of the recording pulse width for different three linear velocities according to an embodiment of the present invention.

### DESCRIPTION OF SYMBOLS

101 Optical disc
102 System control instrument
103 Modulation instrument
104 Recording pulse sequence conversion instrument
105 Laser drive instrument
106 Beam irradiation instrument
107 Rotation control instrument
108 Spindle motor
109 Reproduced signal processing instrument
110 Demodulation instrument
111 Recording condition calculation instrument
1002 OPC area
1003 PIC area

### BEST MODE FOR CARRYING OUT THE INVENTION

Embodiments of the present invention will be described as follows. In the embodiment of the present invention, write-once phase-change optical disc as a recording medium will be explained, and BD-R (write-once type Blu-ray Disc) as an example of the optical disc in particular will be explained. This mention doesn't mean to limit the kind of the recording medium. This invention is a technology to be common to recording medium which records information by injecting energy and forming marks of which physical characteristics is different from non-recorded portion. About the main optical constant and physical format of the blu-ray disc, it is mentioned in “blue-ray disc handbook” (Ohmsha publication). According to the mention, a main parameter of BD-R is as follows, that is, an object lens of which laser wavelength is 405 nm and NA is 0.85 is used, and a BD-R is a phase-change optical disc which has a structure of the disc of which a truck pitch is 0.32 um, a recording surface is one layer or two layers constitution from the laser incidence side, and a thickness of the incident side to the information recording surface is from 75 um to 100 um. The 17PP modulation is used as a modulation method, and the shortest mark (2 T mark) length to be recorded is 0.149 um. The recordable capacity is 25 GB at one side of one layer, and is 50 GB at one side of two layers. The frequency of channel clock is 66 MHz (the frequency corresponds to 264 MHz at BD4X, and corresponds to 528 MHz at BD8X) at the normal speed (1X) of BD, and the linear velocity is the normal linear velocity and its 4.92 m/sec.

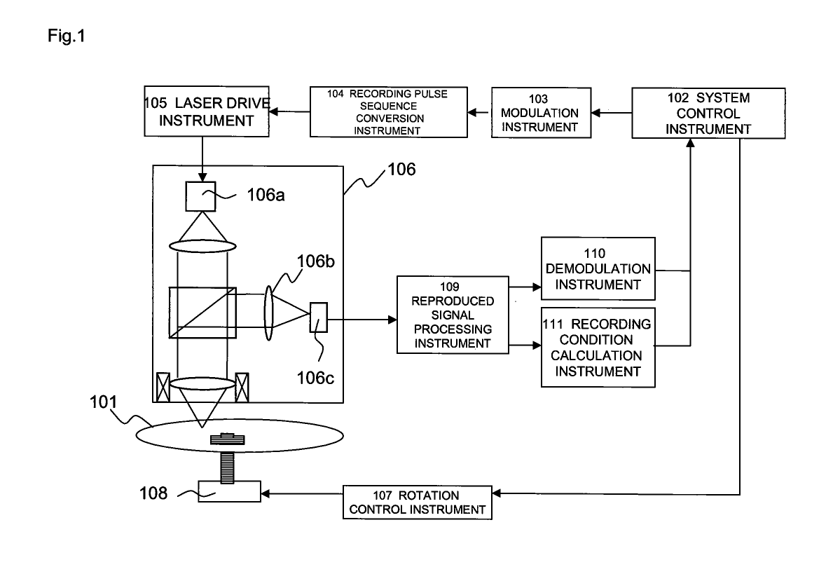

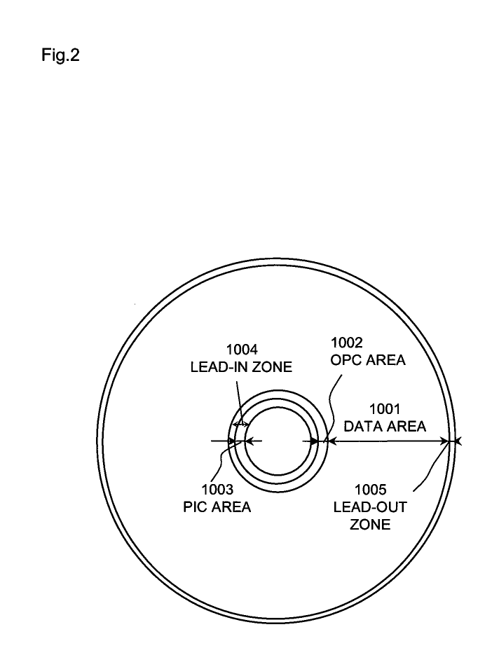

FIG. 1 is a figure explaining an example of the total constitution of the optical information recording and reproducing apparatus according to the present invention. In FIG. 1, reference numeral 101 denotes a BD-R as an optical recording medium (optical disc). FIG. 2 is a figure explaining the constitution of the optical information recording medium. As shown in FIG. 2, a lead-in zone 1004, a data area 1001, and a lead-out zone 1005 are arranged sequentially by the inner side of the optical disc (BD-R). An OPC area 1002 and a PIC (Permanent Information & Control Data) area 1003 are arranged in the lead-in zone. The OPC area 1002 is used to optimize an optimum condition of the recording power and the recording pulse sequence about every disc by test recording, before a data is recorded to the Data area 1001. Moreover, when the individual dispersion of the optical disc apparatus and the environmental changes of the rapid temperature change or the like are occurred, the OPC area 1002 is an area which is used to perform test recording for adjusting the quantity change of the recording power or the recording pulse sequence. The PIC area 1003 is an area which is used to only reproduce, and the area is recorded a structure of the disc, a necessary parameter for calculating a recommended recording power, a recommended value of the recording pulse sequence, a recording linear velocity, a condition for reproducing, or the like by modulating a groove at high-speed. Not shown, but a characteristic number for identifying media is recorded at the inner side part of the PIC area. The characteristic number is recorded by the barcode-shaped signal called BCA (Burst Cutting Area), and the characteristic number is used as the information such as copyright protection.

The Data area 1001 is an area in which a data designated by user is recorded actually on the optical disc, and the Data area is also called “User area”.

There is neither the OPC area for test recording nor the PIC area for only reproducing in the lead-out zone 1005. And the data related to the management information of a recorded data called INFO area is recorded in the lead-in zone 1005. Not shown, but the INFO area is arranged in the lead-in zone of the inner side too, and the common information to the outer side is recorded to the inner side for improving reliability.

And the radius from the center of the disc of each zone is, 22.2-24.0 mm at the lead-in zone, 24.0-58.0 mm at the data area, and 58.0-58.5 mm at the lead-out zone.

When a data is recorded to the BD-R by the CLV method at 4X speed, the number of times of rotation of roughly 8,000 rpm is necessary for the innermost side of the data area, and the number of times of rotation of roughly 3,200 rpm is necessary for the outermost side of the data area. And when a data is recorded to the BD-R by the CLV method at 8× speed, the number of times of rotation of roughly 16,000 rpm is necessary for the innermost side of the data area, and the number of times of rotation of roughly 6,400 rpm is necessary for the outermost side of the data area. In this case, a data is recorded at maximum roughly 4X speed by the CAV method because the number of times of rotation of the spindle motor exceeds 10,000 rpm at the inner side.

In FIG. 1, reference numeral 102 denotes a system control instrument which controls all of the optical information recording and reproducing apparatus of the present invention. Reference numeral 103 denotes a modulation instrument which generates the signal of binarized recording data (NRZI) depending on a test pattern. Reference numeral 104 denotes a recording pulse sequence conversion instrument which converts the NRZI signal of a test pattern into the recording pulse sequence which emits a pulse-like shaped laser depending on the length of the mark. Reference numeral 105 denotes a laser drive instrument which controls and drives laser power. Reference numeral 106 denotes a beam irradiation instrument, and it is an optical pick-up equipped with a laser diode 106a (LD) which irradiates light beam to an optical disc 101 and with a detection lens 106b and with a photodetector 106c. Reference numeral 107 denotes a rotation control instrument, and it controls the number of times of rotation of a spindle motor 108 to become the desired linear velocity depending on the radius position in which a laser irradiated on the optical disc 101. In addition, not shown, a servo instrument which focuses and does tracking a light spot to a track appointed is included. The reproduction operations will be explained as follows. Reference numeral 109 denotes a reproduced signal processing instrument which processes (waveform shaping, binarization, Vitervi decoding, etc.) the reproduced signal (voltage signal) outputted according to the intensity of the receiving light which is the reflected light received from the optical disc 101 by the photodetector and measures various signal index. And reference numeral 110 denotes a demodulation instrument which performs error correction processing (ECC) for the binarized NRZI signal and gets the reproduced data. Reference numeral 111 denotes a recording condition calculation instrument which calculates for optimizing the condition of recording power or the recording pulse sequence according to various signal index (such as the modulation level, asymmetry, β-value, jitter, symbol error rate (SER), etc.) of the reproduced signal of the reproduced signal processing instrument 109.

The optical disc 101 used at the present invention is the BD-R disc which is write-once type and has two layers of one side. The recording film material is TeOPd, and a characteristic of the recording film material is composite material which is dispersed the particles of Te, Te—PD and Pd uniformly at random in a matrix of TeO₂ just after deposition. When this recording film is irradiated by laser, the film melts and a crystal of big particle sized Te or TE—Pd is separated. It is able to detect the difference of each optical condition (reflectivity) at this time as a signal, and based on this, it is able to write only one time, and so-called write-once recording is enabled. When the thermal energy that is higher than constant temperature is irradiated a recording film of such write-once material, crystal is caused, and a record mark is formed. In other words, it has a characteristic that the size of a mark recorded is fixed depending on injection thermal energy per the unit area to be decided by laser power and irradiation time and linear velocity, so that it is a suitable material for a recording film of a write-once optical disc.

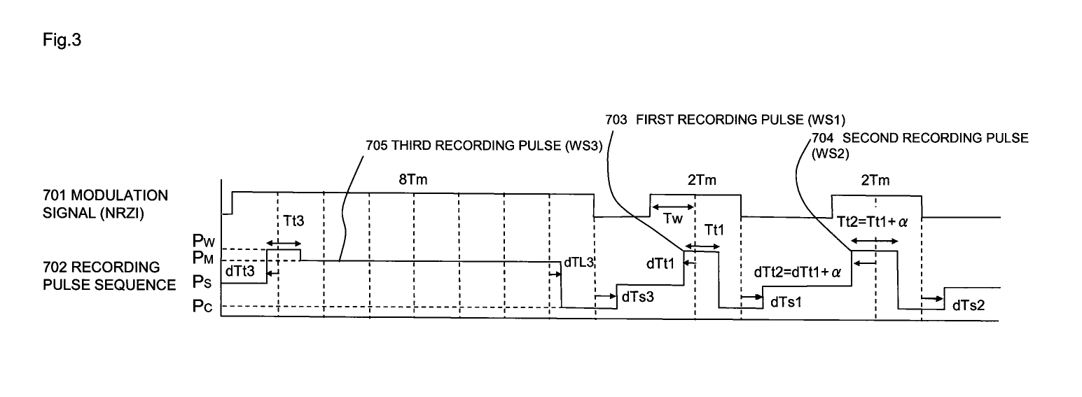

FIG. 3 shows a recording pulse sequence 702 and a modulation signal 701 of the present embodiment. The recording pulse sequence modulation instrument converts the modulation signal 701 into a recording pulse that has each of the length of mark from 2 T to 9T, according to the modulation signal 701 (NRZI) from the modulation instrument. In the recording pulse sequence 702, reference numeral 703 denotes the first recording pulse (WS1) when a 2 T mark is recorded, and reference numeral 704 denotes the second recording pulse (WS2) when a 2 T mark is recorded. Reference numeral 705 denotes the third recording pulse (WS3) when an 8 T mark is recorded. Each recording pulse is performed intensity modulation at power levels of four values at the maximum. The four values are Pw≧Pm≧Ps≧Pc. In FIG. 3, the top pulse is irradiated with the peak power (Pw) that is a recording power of the maximum irradiation intensity, and the time width of the top pulse is represented by Tti (i=1, 2, 3). And the quantity of a shift from the standard clock signal to the rising time of Tti is represented by dTti. And the quantity of a shift from the standard clock signal in the change position from the middle power (Pm) to the cooling power (Pc) is represented by dTLi. And the quantity of a shift from the standard clock signal to the change timing from the cooling power (Pc) to the space power (Ps) is represented by dTsi. The time width Tt2 of the top pulse of the second recording pulses (WS2) is different in only the time width a from the time width Tt1 of the top pulse of the first recording pulses (WS1). When the standard time width is represented by Tw, the time width Tti of the top pulse is a value which is able to normalize by the unit of an integral multiple of Tw/16. That is, it is expressed as follows.

Tti=ni×Tw/16 (ni is integers more than 0) [Formula 5]

An example of “a first recording mark length” of the present invention corresponds to the length of the mark expressed in 2 T (“2 T” is herein also referred to as “ML2”). An example of “a second recording mark length” of the present invention corresponds to the length of the mark expressed in 8 T (“8 T” is herein also referred to as “ML8”).

An example of “said test recording pulses corresponding to said first recording mark length and having a different time width respectively” of the present invention corresponds to each of the first recording pulse (WS1) and the second recording pulse (WS2) mentioned above.

An example of “a test recording pulses corresponding to said second recording mark length” of the present invention corresponds to the third recording pulse (WS3) mentioned above.

The time width of pulse is herein also referred to as simply the pulse width.

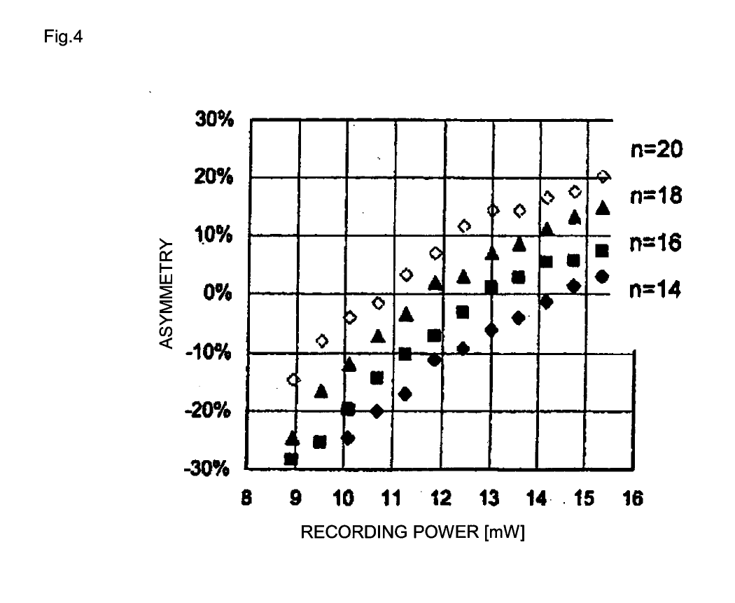

FIG. 4 shows measurements result that has the recording power and the asymmetry of the reproduction signal when normalized four kinds of recording pulse width (n) about the recording mark 2 T of the present embodiment of the present invention are measured.

That is, the time width of the pulse corresponded to the mark length of 2 T which has the first recording pulse 703 (WS1) or the second recording pulse 704 (WS2) in FIG. 3 is represented by Tt=n×Tw/16, and FIG. 4 shows, as the condition of the recording pulse sequence, a relation between the recording power (Pw) and the asymmetry (A) of the reproduction signal when it is recorded at four conditions in n=14, 16, 18, 20.

A recording to Layer 0 of BD-R having two layers has been performed at the condition of which the linear velocity for recording is BD4X (19.7 m/sec). In FIG. 4, for recording at the condition of which the asymmetry of the reproduction signal is same, it is found out that the record power is higher when n of the record pulse is smaller and the record power is lower when n of the record pulse is bigger. In FIG. 4, the recommended asymmetry of the reproduction signal mentioned above is assumed +6% for examples, and the target recording power for each width Tt which reaches the recommended asymmetry is calculated.

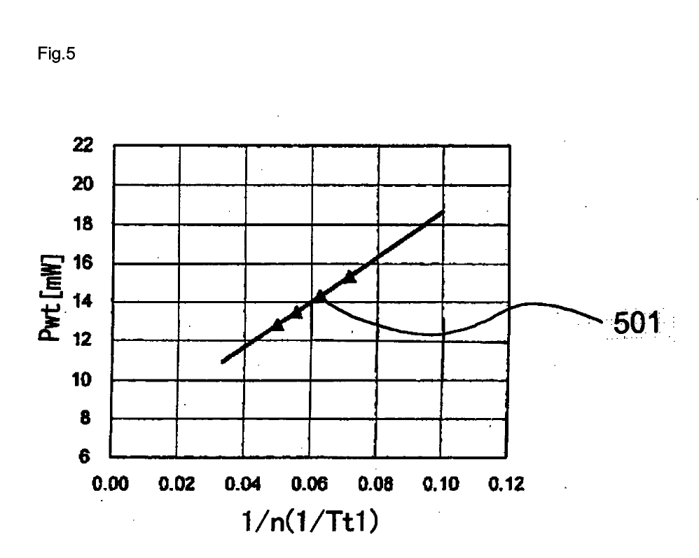

FIG. 5 shows a figure which is plotted a relation between each of the record power Pwt calculated above and the reciprocal number (in a word 1/n) of the value normalized the time width Tt of the top pulse of 2 T at same time by using Tw/16. For example, the target recording power Pwt which makes the asymmetry at n=16 in FIG. 4 to +6% is about 14 [mW], so that the point 501 corresponding to these are plotted in FIG. 5.

In FIG. 5, it is found out that 1/n and the target recording power Pwt which becomes a recommended asymmetry are almost on a straight line.

That is, between the plural time widths Tt of recording pulses and the target recording power Pwt corresponding it, the following relational expression is approved.

Pwt=C1/Tt+C2 (C1 and C2 are the constant) (Formula 1)

This relational expression is expressed as follows.

(Pwt−C2)×Tt=C1

According to the above relational expression, it means that the next mention is a recording condition which makes the asymmetry of the reproduced signal to constant, that is, the product (in a word “injected energy”) of the target recording power Pwt and the recording power irradiation time length Tt becomes constant (C1), and the target recording power Pwt exceeds the threshold power (constant value C2) which is decided depends on the recording material and the linear velocity for recording. Because marks of the same shape is formed when the injected energy becomes constant.

By using that the (Formula 1) is approved, 2 T pulse width Tt with any target recording power Pwt which becomes a recommended asymmetry (Ao) of a reproduced signal can be calculated. In the case of the pulse width Tt of the shortest mark (2 T) in particular, when it is recorded at the high-speed transfer rate, the frequency of the channel clock becomes high and the time width of the pulse of laser modulated in pulse-like shaped becomes short. In the case of the shortest mark 2 T in particular, the influence of rising and trailing time of the laser which is irradiated by the recording power is large for writing by a single pulse, and it is difficult that the recording power and the time width of the recording pulse are controlled precisely by an influence of an overshoot or an undershoot. In the case of the above mention, by calculating the optimum recording power from the recording mark of which the irradiation time length is comparatively long such as 8 T mark by using the reproduced signal, the recording power can be calculated precisely. And the width Tt of the 2 T pulse calculated based on the reproduced signal of the 8 T mark at the optimum recording power Pwo is learned by using the (Formula 1) which is a relational expression mentioned above between the target recording power and the width of the recording pulse. Therefore both of the optimum recording power and the width Tt of the pulse of 2 T mark can be calculated precisely.

### First Embodiment

Hereunder, an embodiment of an information recording method of the present invention will be described more concretely by referring to the drawings. Here, embodiments of an optical information recording apparatus and an optical information recording medium will be described too.

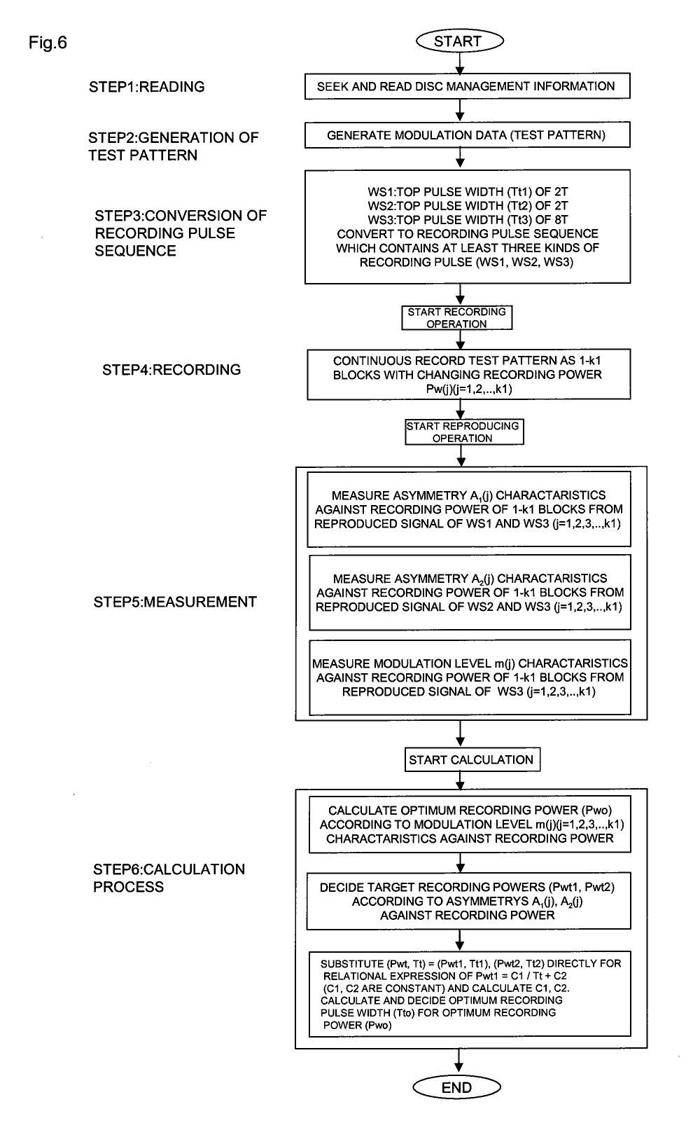

FIG. 6 shows a flow chart which expresses an embodiment of the method which calculates the optimum recording power and the optimum recording pulse width as an example of the present invention. Hereunder, it is described a procedure for learning the optimum recording power and the optimum recording pulse width of 2 T mark with using the optical information recording and reproducing apparatus of the present invention by test recording.

The first step (Step 1) is a step in which seek operation is performed and the disk management information is read.

The beam irradiation instrument 106 (refer to FIG. 1) which is an optical pickup is moved in the PIC area 1003 which is arranged in the part of inner side of the optical disc 101. The system control instrument 102 instructs for the rotation control instrument 107 to control the spindle motor 108 rotating by the linear velocity (19.7 m/sec) corresponding to BD4X. The optical beam which is controlled by focus and tracking reads the initial information (management information) which is recorded at the PIC area 1003 in advance for disc. The disc management information includes the target recording power (Pind), the modulation level (Mind) with the target recording power, the multiplication constant ρ for obtaining the optimum recording power (Pwo) from the target recording power, the multiplication constant κ from the limit recording power (Pth) which is able to begin recording a mark to the target recording power, the ratio (εS=Ps/Pw, εC=Pc/Pw, and εm=Pm/Pw) of each modulation power for the peak power at recording, and the condition (write strategy) of the recording pulse sequence. The condition of the recording pulse sequence is recorded in the PIC area as a disc management information, with a unit of an integral multiple of the interval Tw/16 according to each linear velocity. The value of the disc management information which had been read is stored in the memory of the system control instrument 102 (refer to FIG. 1).

The second step (Step 2) is a step in which a test pattern is generated. The modulation instrument 103 (refer to FIG. 1) generates a test pattern which includes the 8 T single signal and the 2 T single signal, and here, the 8 T single signal is a signal (this is herein also referred to as simply “8 T repeat signal”.) which repeats 8 T marks and 8 T spaces, and the 2 T single signal is a signal (this is herein also referred to as simply “2 T repeat signal”.) which repeats 2 T marks and 2 T spaces.

The third step (Step 3) is a step in which a test pattern is converted to the recording pulse sequence. The recording pulse sequence conversion instrument 104 (refer to FIG. 1) converts the test pattern mentioned above to the first recording pulse (WS1), the second recording pulse (WS2), and the third recording pulse (WS3), and here, the first recording pulse (WS1) has the width Tt1 of the top pulse of 2 T mark depending on the recording pulse sequence which is recorded as the disc management information, the second recording pulse (WS2) has the width Tt2 of the top pulse of 2 T mark and the width Tt2 is extended only the width a from the width Tt1 of the top pulse of the first recording pulse, and the third recording pulse (WS3) has the width Tt3 of the top pulse of 8 T mark. And here, the recording pulse sequence conversion instrument 104 may converts to the 2 T mark of which the pulse width narrows only the width α from the pulse width Tt1, as the second recording pulse which has the pulse width Tt2.

The forth step (Step 4) is a step in which test recording is performed. The laser drive instrument 105 (refer to FIG. 1) controls the beam irradiation instrument 106, and the beam irradiation instrument 106 irradiates the recording power which is a recording power in neighborhood of the target recording power Pind, and which is k1 phases of recording power which is increased the recording power Pw(j) (j=1, 2, 3, . . . , k1) by constant power. By irradiating the recording power of the different k1 kind, the recording pulse sequence which contains the first recording pulse (WS1), the second recording pulse (WS2) and the third recording pulse (WS3) is recorded continuously according to the test pattern which exists in the OPC area 1002.

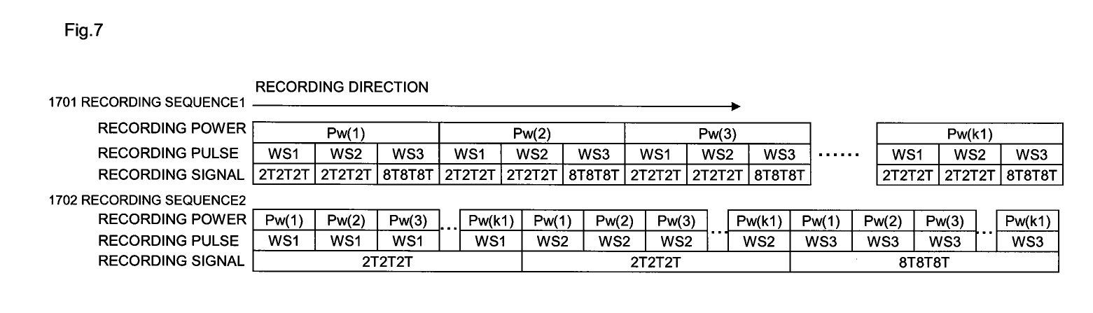

FIG. 7 shows an image of the recording block when each of 1-k1 blocks is recorded. The recording sequence 1701 is a method in which a test pattern contained WS1, WS2 and WS3 is recorded while changing the recording power continuously. The recording sequence 1702 is a method in which a test pattern contained WS1 is recorded while changing the recording power, a test pattern contained WS2 is recorded while changing the recording power continuously next, and a test pattern contained WS3 is recorded while changing the recording power continuously more next.

The fifth step (Step 5) is a step in which a signal performed test recording is reproduced and a signal index is measured.

An example of a reproducing step of the present invention corresponds to the fifth step of the present embodiment.

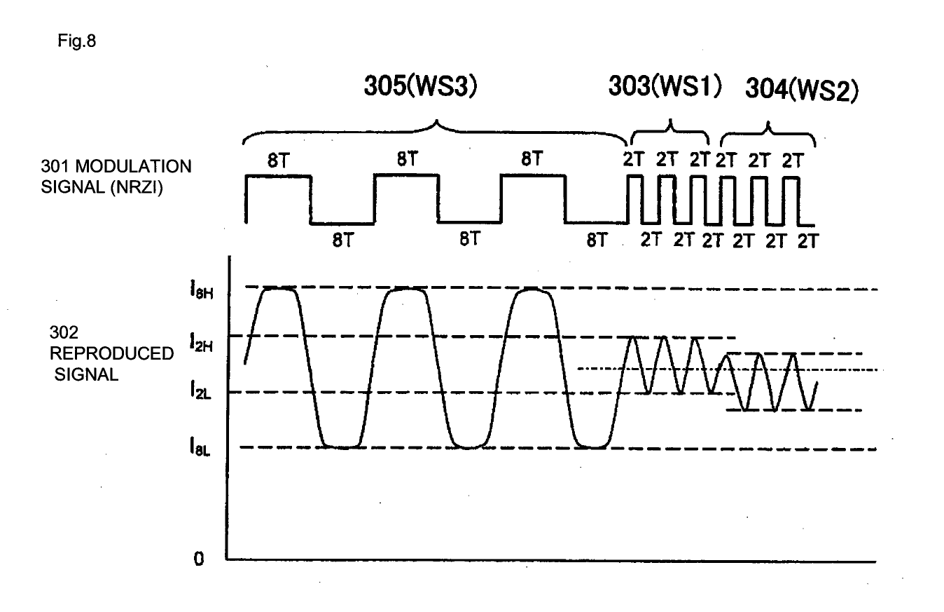

The beam irradiation instrument 106 (refer to FIG. 1) reproduces continuously the blocks which is performed test recording by three recording pulses (WS1, WS2, and WS3) mentioned above. The reproduced signal processing instrument 109 (refer to FIG. 1) measures the modulation level and the asymmetry of the reproduced signal on each recording power and recording pulse of the reproduced signal. Three signals which contain 2 T repeat signal recorded with the first recording pulse 303 (WS1), 2T repeat signal recorded with the second recording pulse 304 (WS2) and 8 T repeat signal recorded with the third recording pulse 305 (WS3) are recorded to a block as a test pattern (modulation signal 301), and FIG. 8 shows a reproduced signal 302 which is outputted from the optical pickup when this block is reproduced. The reproduced signal 302 shows voltage levels which are according to each reflected light of a mark and a space, and I_{8H} represents the voltage level of the 8 T space, and I_{8L} represents the voltage level of the 8 T mark. Similarly, I₂H represents the 2 T space which is the shortest space and I₂H represents the 2 T mark which is the shortest mark. The modulation level m is decided depends on the voltage level of the 8 T mark (comparatively long mark) and the 8 T space, and here, it is calculated with the (Formula 2) by I_{8H} and I_{8L}.

m=(I_{8H}−I_{8L})/I_{8H} (Formula 2)

Similarly, the asymmetry A represents an offset amount of the central value of the voltage level of the 2 T (shortest) mark-space against the central value of the voltage level of the 8 T (longer) mark-space, and is calculated with the (Formula 3) by I_{8H} and I_{8L} each which represents the voltage level of the 8 T space and the 8 T mark and by I_{2H} and I_{8L} each which represents the voltage level of the 2 T space of the shortest space and the 2 T mark of the shortest mark

A=[{(I_{8H}+I_{8L})−(I_{2H}+I_{2L})}/2]/(I_{8H}−I_{8L}) (Formula 3)

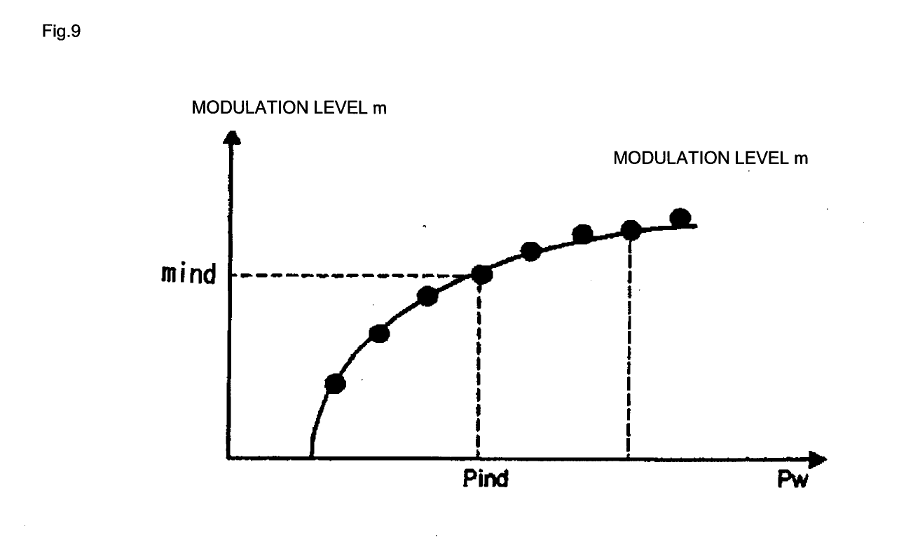

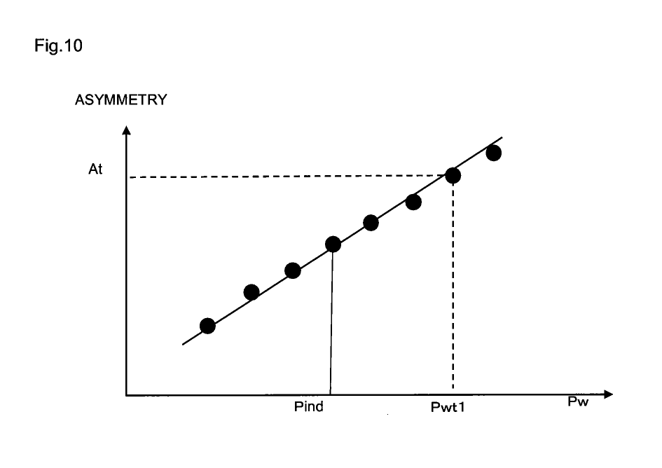

The modulation level m and the asymmetry A are measured in this way. FIG. 9 shows a measured result of the modulation level m of the reproduced signal against the recording power, and FIG. 10 shows a measured result of the asymmetry A of the reproduced signal against the recording power.

FIG. 10 shows the former among the first recording pulse 303 (WS1) at the time which the 2 T mark are recorded and the second recording pulse 304 (WS2) at the time which the 2 T mark are recorded for convenience, but a similar relation can be made a graph in the case of the latter too. Therefore, in FIG. 10, Pwt1 represents the target recording power which is used to obtain the target asymmetry At that is set up by the recommended asymmetry. This is explained at the sixth step.

The sixth step (Step 6) is a calculation process in which the optimum pulse is calculated by a measured result.

An example of a processing step of the present invention corresponds to the sixth step of the present embodiment.

At this step, the optimum recording power Pwo is calculated first, and the target recording power Pwt is calculated next.

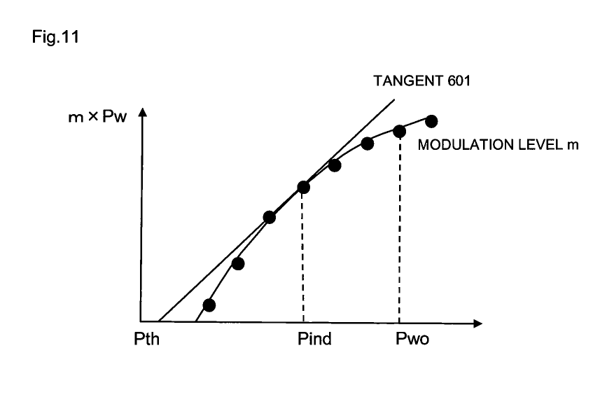

The recording condition calculation instrument 111 (refer to FIG. 1) uses the measured result of the modulation level against the recording power Pw(j) (j=1, 2, 3, . . . , k1) of plural blocks which are performed test recording, and calculates the product of the modulation level of each recording power and the recording power. FIG. 11 shows a result of the product of the modulation level against the recording power and the recording power. The tangent 601 is drawn by using the measured point which is near the target recording power Pind, and the limit recording power Pth is represented by the intercept with the x-axis (power-axis). The optimum recording power (Pwo) is calculated by substituting the limit recording power (Pth), power multiplication constant ρ and κ for the (Formula 4).

Pwo=ρ×κ×Pth (Formula 4)

Next, the target recording power (Pwt1 and Pwt2) with the recording pulse of each of WS1 and WS2 is calculated (refer to FIG. 10), for calculating the optimum pulse width of the 2 T mark.

Concretely, the recording condition calculation instrument 111 set up the target asymmetry At by the recommended β-value of the initial information or the recommended asymmetry, which is recorded in the disc management area or is stored in the memory of the drive. That is, the target recording power Pwt1 (refer to FIG. 10) with the target asymmetry At is calculated by the measured result of the asymmetry of the reproduced signal against the recording power Pw(j) (j=1, 2, 3, . . . , k1) of the first recording pulse (WS1), and the target recording power Pwt2 with the target asymmetry At is calculated (refer to FIG. 10) by the measured result of the asymmetry of the reproduced signal against the recording power Pw(j) (j=1, 2, 3, . . . , k1) of the second recording pulse (WS2). The asymmetry of the reproduced signal is able to calculate by the Formula 3.

Next, the time width Tto of the optimum recording pulse of the 2 T mark is calculated. The recording condition calculation instrument 111, by each target recording power (Pwt1 and Pwt2) of the time width (Tt1) of the first recording pulse and the time width (Tt2) of the second recording pulse, substitutes (Pw, Tt)=(Pwt1, Tt1) and (Pwt2, Tt2) each as a couple of the target power and the time width of the pulse for Pwt and Tt of the (Formula 1), and calculates the constant value C1 and C2 as follows.

C1={(Pwt1−Pwt2)/(Tt2−Tt1)}×Tt1×Tt2

C2=(Pwt2×Tt2−Pwt1×Tt1)/(Tt2−Tt1)

The optimum time width Tto of the pulse of the optimum recording power Pwo is calculated by substituting again C1, C2 mentioned above and the optimum recording power (Pwo) which is calculated from the measured result of the modulation level against the recording power at the fifth step for the (Formula 1).

That is, Tto is calculated by the following the Formula 5, and Tto is stored in the memory of the system control instrument as the optimum time width of the 2 T pulse.

Tto=Tt1×Tt2×(Pwt1−Pwt2)/{Pwo×(Tt2−Tt1)−(Tt2×Pwt2−Tt1×Pwt1)} (Formula 5)

At such above procedure, the optimum recording power Pwo is calculated by the modulation level characteristics of the reproduced signal of the comparatively long mark-space like 8 T, and the optimum time width (Tto) of the recording pulse of the shortest mark (2 T) with the optimum recording power is decided.

As described above, even when a data is recorded at the high-speed transfer rate and the influence of rising time and trailing time of the laser for recording is big, the recording power and the time width of the recording pulse sequence are controlled precisely, and good recording quality can be maintained.

And using the calculated result of the (Formula 1), the optimum pulse width can be calculated by performing test recording with at least two kinds of 2 T pulse width. Therefore, the width of the 2 T recording pulse can be optimized in a short time, without plural of performing test recording, by a continuous recording and continuous reproduction. And the width of the 2 T recording pulse can be optimized effectively without wasting the number of the recording block.

Moreover, in the case of the recordable optical disc like the BD-R which has the OPC area less than the Data area and can be recorded only once to same track, a consumption of the recording track in the OPC area can be reduced, and the effect extending the use life of the disc by using up the test recording area is exist.

A way in which the optimum recording power Pwo and the optimum pulse width Tto of the 2 T mark for one of linear velocity is calculated is described in this embodiment of the present invention. However, the optimum recording power Pwo and the optimum recording pulse width Tto can be calculated by using same procedure about plural of different linear velocities. This is described in the second embodiments of the present invention.

And in this embodiment of the present invention, as one example of a first recording mark length of the present invention, a way in which the emission width of the peak power level for recording the shortest mark (2 T mark length) is optimized is described. However, the width of the top pulse of the recording pulse sequence except 2 T mark can be calculated by using same procedure. That is, in the case of DVD for example, the shortest mark length is 3 T, the test pattern of the embodiment of the present invention may contains two repeat signals. One of the repeat signals repeats 3 T mark and 3 T space corresponding to the first mark length and another one of the repeat signals repeats mark and space of which any one length at least among 6 T-14 T corresponding to the second mark length.

And, the optimum pulse length Tto of the 2 T mark which is calculated by using the procedure described in the embodiment of the present invention and the initial value of Tt width of 2 T recorded as a disc management information are compared, and the difference of this comparison result can be used as the pulse width of the top pulse which has other mark length.

In the embodiment of the present invention as shown in FIG. 8, the signals which were modulated by the 8 T single signal and the 2 T single signal are recorded synchronously, and the asymmetry of the reproduced signal is measured, then the condition of the optimum recording pulse sequence is calculated. However, the optimum recording pulse width can be calculated too by using the β-value which is another signal index or the 2 T level (I₂m) which is described later instead of the asymmetry of the reproduced signal. In this case, the relation of the (Formula 1) is approved similarly by substituting the signal index which is the β-value or the 2 T level for the axis of ordinate in FIG. 4 or FIG. 10.

Each of the asymmetry A of the reproduced signal, the p-value and the 2 T level corresponds to one example of a first signal index of the present invention. The modulation level m of the reproduced signal corresponds to one example of a second signal index of the present invention.

The relation between the asymmetry and the recording power which is shown in FIG. 4 and FIG. 10 corresponds to a first signal index characteristic of the present invention. The relation between the recording power and the product of the modulation level multiplied by the recording power which is shown in FIG. 11 corresponds to a second signal index characteristic of the present invention.

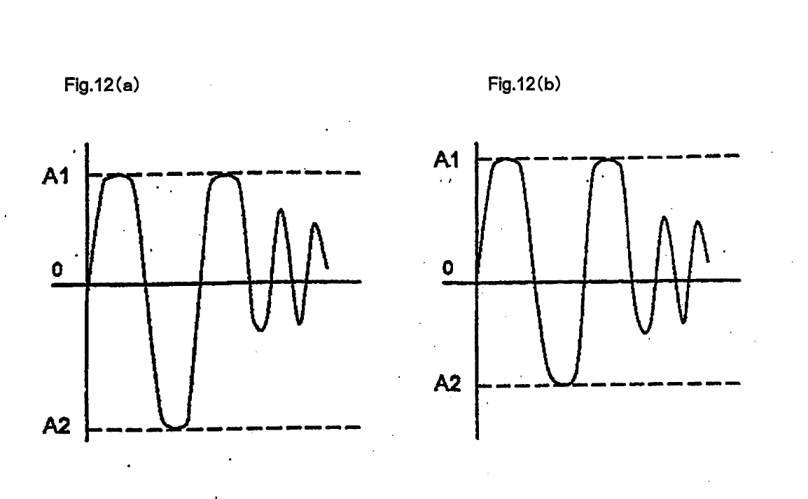

FIG. 12(a) and FIG. 12(b) are figures explaining a β-value of the present invention. The β-value is a signal index which is expressed by following the Formula, which uses the high voltage level A1 and the low voltage level A2 of the reproduced signal that are coupled by AC with the reproduced signal outputted from the reproduced signal processing instrument.

β=(A1+A2)/(A1−A2) (Formula 6)

By using above β, the recording pulse width can be optimized by using the recommended β-value which is recorded in the disc management information.

That is, the asymmetry which is a parameter of the axis of ordinate in FIG. 4 and FIG. 10 can be replaced to the β-value. Then, when the p-value is used as a first signal index of the present invention, the above explanation about using the asymmetry of the reproduced signal can be just applied.

In the case of FIG. 12(a), the β-value becomes a negative value, and the lack of the recording power is shown. In the case of FIG. 12(b), the β-value becomes nearly zero, and it is shown that the recording power is optimum.

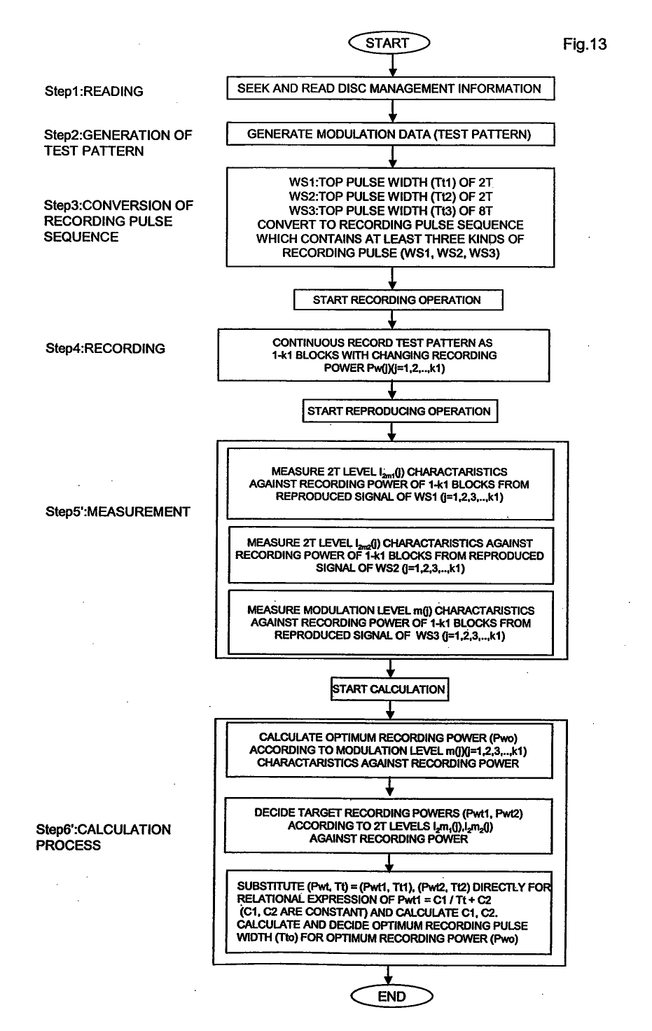

Step 1-Step 4, Step 5′, and Step 6′ in FIG. 13 show the procedure in which the optimum pulse width is calculated by using the 2 T level (I₂m) of the 2 T reproduced signal instead of the asymmetry of the reproduced signal as the signal index.

In this case, the 2 T level is a signal index decided not by a relation of the height of a relative signal level between a long mark-space and a short mark-space such as the asymmetry (A) of the reproduced signal but by the reproduced signal levels (“L” level and “H” level) of 2 T mark and 2 T space. Therefore, the condition of the recording pulse sequence of the 2 T mark can be calculated precisely regardless of the recording condition of a long mark

Here, the 2 T level (I₂m) is defined by the following the Formula. Ig means the level of reflected light about the non-recorded condition.

I₂m=1−{(I₂H+I₂L)/2}/Ig (Formula 7)

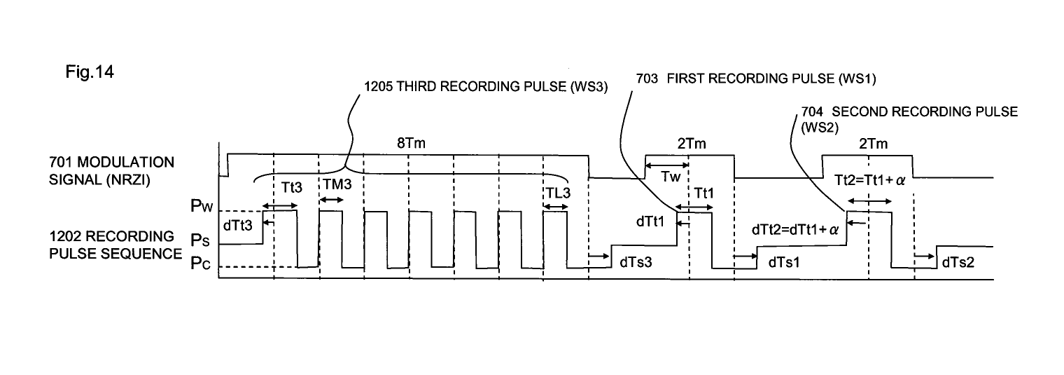

In this embodiment of the present invention, the explanation based on what is called a castle type write strategy (the condition of the recording pulse sequence) which is shown in FIG. 3 as the condition of the recording pulse sequence is described. However, it goes without saying that the optimum recording pulse width can be calculated by using same procedure, even at the case of that the recording pulse sequence 1202 is assumed what is called a N−1 type write strategy of which the number of the pulse irradiated with peak power has less one (the number of the recording pulse sequence is seven (refer to the third recording pulse 1205) in FIG. 14) against the recording mark length N (N=8 Tm in FIG. 14) shown in FIG. 14.

In the second step in the embodiment of the present invention, the 8 T single signal and the 2 T single signal which continued are performed test recording to the OPC area as a test pattern. The interference between the codes of the reproduced signal between different mark-spaces can be got rid by using such as the test pattern for recording, and the signal index, which is such as the modulation level of the reproduced signal or the asymmetry or the 2 T level (I₂m), can be calculated more precisely. Then, the optimum recording power and the recording pulse width are can be calculated precisely.

In this embodiment of the present invention, a case of recording the 2 T repeat signal and the 8 t repeat signal as a test pattern of the single signal for improving the reliability of the reproduced signal is described. However the case is not liming, for example, one combination of a mark and a space may be recorded instead of repetition of each signal

And it is not limiting to use a test pattern of the single signal, and a test pattern which is modulated with 17PP modulation or 8-16 modulation, or what a signal is a random signal of which the appearance frequency each of the mark length is approximately constant may be used for recording. By recording the test pattern which modulated with 17PP modulation or 8-16 modulation, the jitter and the SER (symbol error rate) can be measured. Then, the signal quality of the recording mark can be measured more precisely.

In the embodiment of the present invention, the optimum recording power is calculated by using the product of Pw and the modulation level when the optimum recording power is calculated. However, another way in which the optimum recording power is calculated by using the product of the nth power of recording power and the modulation level may be used.

In the embodiment of the present invention, constants C1 and C2 are calculated by test recording in the OPC area. The constants C1 and C2 which are calculated once are stored in a memory of the system control instrument, and the condition of the optimum recording pulse sequence may be calculated based on the known C1 and C2 when the same disc is inserted to the optimum disc apparatus next.

C1 and C2 may be stored by recording in the INFO area of the optical disc. It is not necessary that the OPC area is performed test recording by two recording pulse widths when the recording pulse width is calculated by reading the known C1 and C2. And then, the optimum recording pulse width can be calculated by the result of the target recording power Pwt which is performed test recording with one recording pulse width. Then, the time for the test recording can be shortened, so that an effect to be shorting the waiting time of user is obtained.

### Second Embodiment

Hereunder, another embodiment of an information recording method of the present invention will be described more concretely by referring to the drawings. Here, embodiments of an optical information recording apparatus and an optical information recording medium will be described too. The action and the effect of each component of the optical information recording apparatus in this embodiment of the present invention is different from that of the first embodiment as described later, but FIG. 1 is used as a constitutional view for convenience.

In the first embodiment, the method of learning the optimum recording power Pwo for one specific linear velocity and the optimum recording pulse width Tto of the 2 T mark at same time was described. In the second embodiment of the present invention, the method of learning the optimum recording power and the optimum recording pulse width for plural of linear velocities was described.

In the second embodiment of the present invention, the procedure in which the optimum recording power and the optimum recording pulse width is calculated at three conditions of the linear velocity relation will be described. The three conditions are Lv1(2X:4.92 m/sec)<Lv2(4X:9.84 m/sec)<Lv3(8X:19.7 m/sec).

When a data is recorded to the BD-R at 4X speed, the number of times of rotation of roughly 8,000 rpm is necessary for the innermost side of the data area, and the number of times of rotation of roughly 3,200 rpm is necessary for the outermost side of the data area. And when a data is recorded to the BD-R at 8X speed, the number of times of rotation of roughly 16,000 rpm is necessary for the innermost side of the data area, and the number of times of rotation of roughly 6,400 rpm is necessary for the outermost side of the data area. In this case, a data is recorded at maximum roughly 4X speed by considering the limit of the number of times of rotation of a spindle motor and safety, because the number of times of rotation of the spindle motor exceeds 10,000 rpm at the inner side. The area which is recorded at 8X speed is recorded with the CAV method at the outer side mainly.

The optimum recording power and the optimum pulse width Tto, each for the first linear velocity Lv1 and the second linear velocity Lv2, can be calculated by using the procedure of the first embodiment mentioned above. However, when the third linear velocity Lv3 is 8X, the condition of the recording power and the recording pulse cannot be optimized by performing test recording to the OPC area of the inner side because the number of times of rotation of the spindle motor exceeds 10,000 rpm of limited rotation at the inner side.

Here, the channel clock at the time when a data is recorded at the third linear velocity Lv3 is assumed to be more than 330 MHz. This channel clock is explained in brief here. At the case of BD, the number of times of rotation of the spindle motor for the innermost side (r=24 mm) with 4X (4X drive speed) is roughly 8,000 rpm, then at the case of with roughly 5X (5X drive speed), the number of times of rotation becomes 10,000 rpm. Because 1X is 66 MHz, 5X becomes 66 MHz (channel clock)×5=330 MHz.

Then, in the second embodiment of the present invention, the method, in which the recording power and the optimum recording pulse width for the third linear velocity are calculated according to in particular the optimum recording power and the optimum recording pulse width that are optimized for the linear velocity Lv1 and Lv2, is described.

Firstly, the optimum recording power and the optimum recording pulse width for two linear velocities Lv1 and Lv2 are calculated by using the procedure which is shown in the flowchart of FIG. 6 and FIG. 13.

For the first linear velocity Lv1 which is optimized by the procedure shown in the flowchart, the optimum recording pulse width of 2 T is represented by Ttv1, the integral value which is obtained by normalizing the Ttv1 with Tw/16 is represented by nv1, and the target recording power is represented by Pwtv1. For the second linear velocity Lv2 which is optimized by the above procedure, the optimum recording pulse width of 2 T is represented by Ttv2, the integral value which is obtained by normalizing the Ttv2 with Tw/16 is represented by nv2, and the target recording power is represented by Pwtv2. And each of these values is stored in the memory of the system control instrument 102 (refer to FIG. 1).

2X (Tw=7.58n) is assumed LV1, 4X (Tw=3.79 n) is assumed Lv2, and 8X (Tw=1.89 n) is assumed Lv3. In this case, the pulse time width is necessary 2[ns] or above to control the recording power precisely and to record by desired power, with due regard to the rising speed of and the trailing speed of the laser.

That is, the following is formulas in which this is expressed.

Tw/16×nv1≧2 [ns]

Tw/16×nv2≧2 [ns]

Tw/16vnv3≧2 [ns]

Therefore, to let the laser diode 106a emit with the pulse time width of 2[ns] or above, the pulse width nv (nv is obtained by “Ttv=nv×Tw/16≧2[ns]”) of nv2=9 (9×Tw/16 nearly=2.13[ns]) or above is necessary at the case of 4X, and the pulse width nv of nv3=17 (17×Tw/16 nearly=2.01[ns]) or above is necessary at the case of 8X.

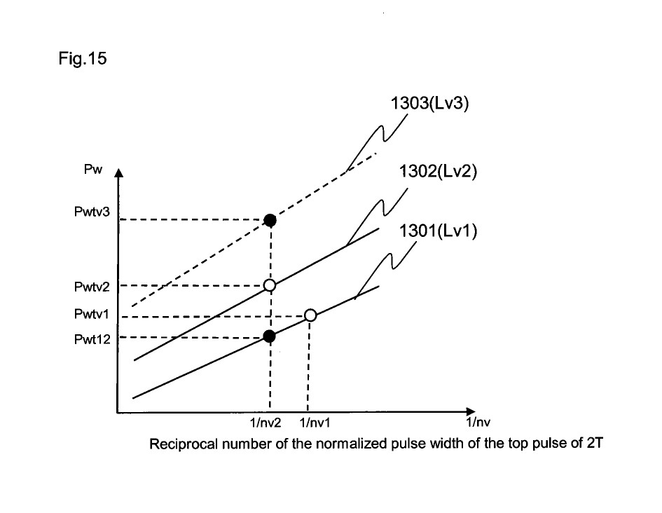

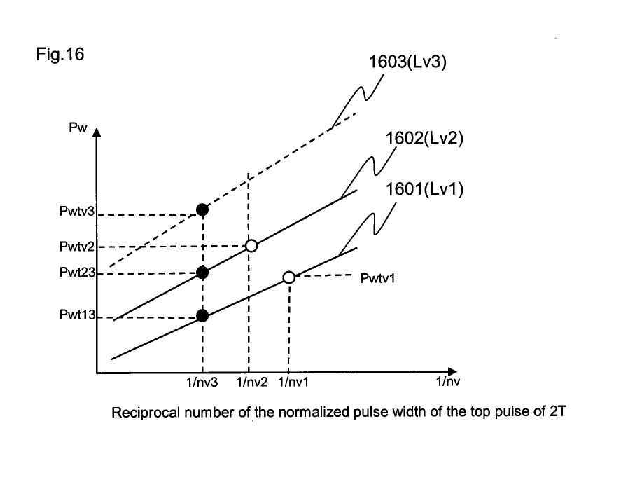

FIG. 15 and FIG. 16 show a relation between the target recording powers and the reciprocal number (1/nv) of the optimized pulse width, at the first linear velocity and the second linear velocity. Here, straight line 1301 (Lv1) and straight line 1302 (Lv2) which show relations at each linear velocity are straight lines which were calculated by using the Formula 1 explained in the first embodiment.

nv2 (≧17), as shown in a white circle on the straight line 1302 (Lv2) in FIG. 15, is a normalized pulse width which corresponds to the optimum recording power Pwtv2 for the second linear velocity Lv2. In this case, the optimum recording pulse width Ttv2 can be expressed with Ttv2=nv2×Tw/16. nv1, as shown in a white circle on the straight line 1301 (Lv1) in FIG. 15, is a normalized pulse width which corresponds to the optimum recording power Pwtv1 for the first linear velocity Lv1. In this case, the optimum recording pulse width Ttv1 can be expressed with Ttv1=nv1×Tw/16.

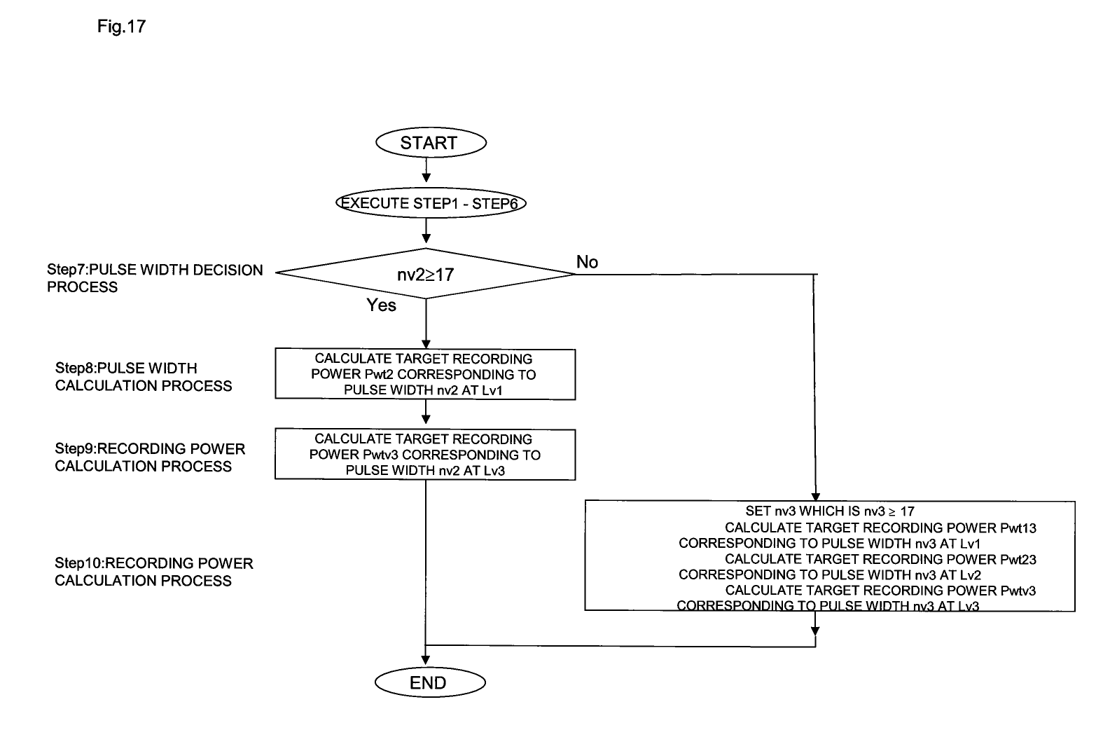

FIG. 17 shows a procedure, of the embodiment in the present invention, in which the optimum recording power and the optimum pulse width of the recording pulse for three different linear velocities are decided.

Here, the values which are calculated by Step 1-Step 6 of the first embodiment are used as the optimum power and the pulse width for the linear velocities Lv1 and Lv2. That is, as described above, the following values are stored in the memory of the system control instrument 102 (refer to FIG. 1). Each of the value is listed; the optimum recording pulse width Ttv1 of 2 T for the first linear velocity Lv1; the normalized integral value nv1; the target recording power Pwtv1; the optimum recording pulse width Ttv2 of 2 T for the second linear velocity Lv2; the normalized integral value nv2; and the target recording power Pwtv2.

Step 7 is a pulse width decision process. At the case of calculating the pulse width nv3 when a recording is done at the third linear velocity Lv3, each of the normalized pulse widths with Lv2 is sorted in each of two cases which are one case of nv2≧17 and the other case of nv2<17.

The first case is a case of nv2≧17. That is, when the normalized pulse width (nv3) by Tw/16 for the third linear velocity Lv3 is the same as the normalized pulse width (nv2) by Tw/16 for the second linear velocity Lv2 and is a width which is to be able to emit the light (nv3=nv2>nv1), the procedure of step 8 is performed next.

The second case is a case of nv2<17. That is, the case is this, when the normalized pulse width by Tw/16 for the second linear velocity Lv2 is used as the normalized pulse width by Tw/16 for the third linear velocity Lv3, the pulse length is insufficient. And in this case, the procedure of step 10 is performed next.

Step 8 is a pulse width calculation process. When a recording is performed at the first linear velocity Lv1, the target recording power Pwt12 corresponding to the recording pulse width nv2 is calculated by using a relation of the Formula 1 (refer to a black point on the straight line 1301 (Lv1) in FIG. 15). That is, the recording condition calculation instrument 111 (refer to FIG. 1) of the optical information recording and reproducing apparatus of the embodiment of the present invention uses constants C1 and C2 for the first linear velocity Lv1 and calculates the power Pwt12 corresponding to the recording pulse width nv2 by using (Formula 1).

Step 9 is a recording power calculation process. This process is a method in which the optimum recording power Pwtv3 corresponding to the pulse width nv2 is calculated at the third linear velocity Lv3. That is, the recording condition calculation instrument 111 of the embodiment of the present invention uses the target recording powers Pwt12 and Pwtv2 corresponding to the pulse width nv2 for the first linear velocity Lv1 and the second linear velocity Lv2 (refer to a black point on the straight line 1301 (Lv1) and a white circle on the straight line 1302 (Lv2) in FIG. 15), and calculates the optimum recording power Pwtv3 for the third linear velocity Lv3 as Pwtv3=Pwtv2/Pwt12×Pwtv2 (refer to a black point on the straight line 1303 (Lv3) in FIG. 15).

Step 10 is a pulse width calculation process. The pulse width for the third linear velocity Lv3 is set to the arbitrary one pulse width nv3 which satisfies nv3≧17.

Next, the target recording power Pwt13 corresponding to the recording pulse width nv3 is calculated (refer to a black point on the straight line 1601 (Lv1) in FIG. 16) by using the relation of the (Formula 1) when a recording is performed at the first linear velocity Lv1. That is, the recording condition calculation instrument 111 of the embodiment of the present invention uses constants C1 and C2 for Lv1 and calculates the target recording power Pwt13 corresponding to the recording pulse width nv3 by using the (Formula 1).

Similarly, the target recording power Pwt23 corresponding to the recording pulse width nv3 is calculated (refer to a black point on the straight line 1602 (Lv2) in FIG. 16) when a recording is performed at the second linear velocity Lv2. That is, the recording condition calculation instrument 111 uses constants C1 and C2 for the second linear velocity Lv2 and calculates the target recording power Pwt23 corresponding to the recording pulse width nv3 by using the (Formula 1).

Next, the optimum recording power Pwtv3 corresponding to the recording pulse width nv3 is calculated (refer to a black point on the straight line 1603 (Lv3) in FIG. 16) when a recording is performed at the third linear velocity Lv3. That is, the recording condition calculation instrument 111 uses the target recording powers Pwt13 and Pwt23 corresponding to the pulse width nv3 when a recording is performed for the linear velocities Lv1 and Lv2, and calculates the optimum recording power Pwtv3 for the third linear velocity Lv3 as Pwtv3=Pwt23/Pwt13×Pwt23.

As described above, Pwtv3 and nv3, which are calculated by the procedures of Step 7-Step 10, is set to each the optimum recording power and the optimum recording pulse width for the third linear velocity Lv3. By using such procedures, the optimum recording power and the optimum recording pulse width can be calculated by using the relation of the (Formula 1) for each linear velocity even about a linear velocity at learning can not be performed by using the OPC area 1002 (refer to FIG. 2) of the inner side of the optical disk like 8X (8X drive speed of BD).

An example of a target recording power obtaining step of the present invention corresponds to a step which includes Step 7, Step 8 and a part of Step 10 of the present embodiment of the present invention.

An example of an optimum recording power obtaining step of the present invention corresponds to a step which includes Step 9 and a part of Step 10 of the present embodiment of the present invention.

In this embodiment of the present invention, a case in which the optimum recording pulse widths nv1, nv2 for the first and the second velocities Lv1, Lv2, or the like are calculated as values corresponding to the desired time width of the recording pulse and are stored in the memory of the system control instrument by using steps which are described in the first embodiment is described. However it is not limited thereto, it is not necessary to use nv1 and nv2 themselves, for example, values which are related the normalized optimum recording pulse widths nv1 and nv2 for the first and the second velocities Lv1, Lv2 may be used. These values may be calculated by other method (e.g. generally known method) with the above, or a part of these values may be stored in advance in the above memory or the like as the initial values.

In the second embodiment of the present invention, for an example, a case in which Lv1=2X, Lv2=4X, and Lv3=8X are used as linear velocities, that is, the case in which each of the velocities increases by double as well as Lv3/Lv2=Lv2/Lv1 is described. However it is not limited thereto, at a case of recording by the CAV method, Lv3 is 2.4 times faster than Lv2 because the linear velocity of the outer side of an optical disc is 2.4 times faster than it of the inner side at maximum. In this case it is expressed as follows.

Lv2/Lv1=2, LV3/Lv2=2.4

Pwtv3=Pwtv2×(Pwtv2/Pwtv1)̂Log₂(2.4)

That is, it is expressed as an general solution as follows.

Pwtv3=Pwtv2×(Pwtv2/Pwtv1)̂Log₂(RLx)

Here, RLx is a ratio of arbitrary line speed Lv3 to Lv2. It may be expressed with RLx=Lv3/Lv2.

At the Step 7 in the second embodiment of the present invention, at the case of calculating the pulse width nv3 when a recording is done at the third linear velocity Lv3, each of the normalized pulse widths with Lv2 is sorted in each of two cases which are one case of nv2≧17 and the other case of nv2<17. However, when the maximum recording linear velocity is known in advance, the pulse width nv3 (nv3 is obtained by “Ttv3=nv3×Tw/16”) which is obtained by normalizing the recording pulse width exceeding 2 ns for the maximum linear velocity Lv3 may be recorded in advance to the disc management area.

The normalized pulse widths nv1 and nv2 for the linear velocities Lv1 and Lv2 at which enable to learn at the OPC area 1002 of the inner side of an optical disc are set as values of more than 17 and may be recorded in the disc management information in advance. Therefore the normalized pulse width nv3 for the maximum linear velocity Lv3 becomes a value of more than 17, so that the laser irradiation time of more than 2 ns can be secured. In this case, the decision in Step 7 is not necessary, the recording power and the recording pulse width can be calculated by the procedures of Step 8 and Step 9, then the optimum recording power and the recording pulse width can be calculated by using these procedures more precisely than by using the procedure of Step 10.

At the Step 10, an arbitrary pulse length which is nv3≧17 is not only set, by using the optimum pulse width (nv1) normalized for the first linear velocity Lv1 and the optimum pulse width (nv2) normalized for the second linear velocity Lv2, the optimum pulse width (nv3) normalized for the third linear velocity Lv3 may be recorded using the normalized recording pulse width which is integer nv3 (nv3 is obtained by “nv3/nv2=nv2/nv1”). In this case, plural of the intermediate calculate processing are not necessary to be performed, and the optimum recording power can be calculated by a proportional calculation.

In the embodiment of the present invention, the recording condition for the third linear velocity Lv3 is not recorded in the disc management information. However it is not limited thereto, for an example, the recommended pulse widths which are normalized for different three linear velocities may be recorded in the disc management area in advance by using a parameter which is optimized at a condition n1=n2=n3. When the recommended pulse widths are recorded in the disk management area at such a condition, the recording condition for the high-speed linear velocity Lv3 in which a learning is difficult at the learning area of the inner side can be learned by using same normalized pulse width of low-speed linear velocities Lv1 and Lv2, then the recording power and the recording pulse width can be calculated more precisely.

In this case, for same reason the above, it is desirable that each recommended pulse width n1-n3 is set being more than 2[ns] (Tw/16×ni≧2[ns]; ni is positive integer (i=1, 2, 3)).

In the embodiment of the present invention, the recording condition for the third linear velocity Lv3 is not recorded in the disc management information. However, the recommended pulse widths which are normalized for different three linear velocities may be recorded in the disc management area in advance by using a parameter optimized at a condition n3=n2≧n1. When the recommended pulse widths are recorded in the disk management area at such a condition, the recording condition for Lv3 in which a learning is difficult at the learning area of the inner side can be learned by using same normalized pulse width of low-speed Lv1 and Lv2, then the recording power and the recording pulse width can be calculated more precisely.

In the description of the present invention, the recommended pulse widths are assumed to be recorded in the disc management area or the like in advance, and are expressed by symbols n1, n2 and n3. The other side, in the case of being expressed the normalized optimum pulse width with a combination of a drive apparatus and a disc when a test recording is performed actually and the optimum pulse width is calculated, symbols nv1, nv2 and nv3 are used.

In the embodiment of the present invention, when the space power levels for different three linear velocities Lv1, Lv2 and Lv3 are referred to as Ps1, Ps2 and Ps3, the space power ratio to the peak power may be constant for each linear velocity. By doing in this way, the pulse width of the recording pulse can be calculated more precisely.

In the embodiment of the present invention, for an example, a case in which the time width of the peak power level of the recording pulse sequence at the time of recording the shortest mark is different is described. However it is not limiting to use the recording pulse width, the power ratio of which the middle power to the peak power or the power level of which the space power to the peak power is used as a condition for the recording pulse, and recording is performed with two of ratios of each of that by using a test pattern, and the optimization may be performed. Not only the pulse width but also the power ratio can be optimized.

In the embodiment of the present invention mentioned above, a case of a constitution in which both the optimum recording power and the optimum recording pulse width for obtaining high reproduced signal quality are decided more precisely is described. However it is not limited thereto, for an example, it is may be a constitution in which the value obtained by other method (e.g. generally known method) is used as the optimum recording power and the present invention is applied for deciding the optimum recording pulse width.

In the embodiment of the present invention mentioned above, a case in which the asymmetry of the reproduced signal is used as a first signal index when the optimum recording pulse is decided is described. However it is not limited thereto, for an example, it has been described already that the following constitution is may be used, that is, the optimum recording pulse width is calculated by using the 2 T mark length, the 2 T space length and the 2 T level (I₂m) as a first signal index, and the 2 T level is a signal index decided by the reproduced signal level of the reflected light with non-record state. In this case, for an example, when a constitution in which the optimum recording power is calculated by a generally known method or a constitution in which a data recorded in the disc management area in advance as a recommended recording power is used or the like constitution is used, the second recording mark length (e.g. 8 T mark length) which is longer than the 2 T recording mark length may not be contained in the test pattern of the present invention.

In the embodiment of the present invention mentioned above, a case of a constitution in which a test pattern containing the 2 T single signal and the 8 T single signal is generated is described. However it is not limited thereto, for an example, it is may be a constitution in which the test pattern contains a repeat signal that repeats 2 T mark and 2 T space and another repeat signal that repeats a mark and a space of which any one length at least among 5 T -9 T corresponding to the second mark length.

In addition, the program according to the present invention is a program of making a computer execute the operation of all or a part of steps of the information recording method of the present invention mentioned above, and is a program which operates in collaboration with a computer.

Moreover, the recording medium of the present invention is a recording medium which records a program for executing all or a part of operation of all or a part of steps of the information recording method of the present invention, mentioned above, by a computer, and is a recording medium for the above-mentioned program being readable by a computer and executing the above-mentioned operation with collaborating with the above-mentioned computer.

In addition, the above-mentioned “a part of steps” of the present invention means one or some of a plurality of steps.

Moreover, the above-mentioned “operation of steps” of the present invention means the operation of all or a part of the above-mentioned steps.

In addition, one utilizing form of the program of the present invention may be an aspect of being recorded on a recording medium, ROM and the like are included, which can be read by a computer, and operating with collaborating with the computer.

Moreover, one utilizing form of the program of the present invention may be an aspect of being transmitted inside a transmission medium, transmission media such as the Internet, light, radio waves, and acoustic waves and the like are included, being read by a computer, and operating with collaborating with the computer.

Furthermore, a computer according to the present invention described above is not limited to pure hardware such as a CPU and may be arranged to include firmware, an OS and, furthermore, peripheral devices.

Moreover, as described above, configurations of the present invention may either be realized through software or through hardware.

As described above, the information recording method of an embodiment of the present invention is a information recording method for calculating the optimum recording power of an optical information recording medium and the optimum time width of the recording pulse. The information recording method is characterized by the following movement. That is, in the information recording method, a test pattern which contains two of recording mark length ML2, ML8 (Here, ML2<ML8) at least on the optical information recording medium is generated. The test pattern is converted to a recording pulse sequence which contains two different recording pulses WS1, WS2 corresponding to the mark length ML2 (Here, the time width Tt1 of the peak power level of WS1 is different from the time width Tt2 of the peak power level of WS2) and a recording pulse WS3 corresponding to the mark length ML8. The test pattern is recorded on the test recording area as plural blocks, by the three recording pulses and by plural recording powers while changing recording power. The plural blocks are reproduced for obtaining a reproduced signal from the optical information recording medium. The first signal index corresponding to the recording power is measured from a part which was recorded with the recording pulses WS1, WS2 among the reproduced signal. The second signal index corresponding to the recording power is measured from a part which was recorded with the recording pulse WS3 among the reproduced signal. The optimum recording power (Pwo) is decided depending on the measurements result of the second signal index. Target recording powers Pwt1, Pwt2 corresponding to the recording pulses WS1, WS2 are decided depending on the first signal index. Lastly, the optimum time width Tto of the recording pulse for the recording mark length ML2 is calculated from the Pwo, Pwt1, Pwt2, Tt1, and Tt2 by calculation.

In the information recording method of an embodiment of the present invention, the target power Pwt and the time width Tt of the peak power level are expressed by the following relational expression.

Pwt=C1/Tt+C2 (Formula 1)

(C1 and C2 are constants)

It is a characteristic that the target power Pwt or the time width Tt of the peak power level is found by calculation with the (Formula 1).

The information recording method of an embodiment of the present invention mentioned above is characterized by the following operation. That is, the target powers Pwt1, Pwt2 of the recording pulses WS1, WS2 are decided from a measurement result of the first signal index among the reproduced signal. And, the optimum time width Tto of the recording pulse of the mark length ML2 is calculated by using the following the Formula 5 depending on the target recording powers Pwt1, Pwt2, the time widths Tt1, Tt2 of the peak power level and the optimum recording power (Pwo).

Tto=Tt1×Tt2×(Pwt1−Pwt2)/{Pwo×(Tt2−Tt1)−(Tt2×Pwt2−Tt1×Pwt1)} (Formula 5)

The information recording method of an embodiment of the present invention mentioned above is a method in which the optical information recording medium is recorded at three different linear velocities (Lv1<Lv2<Lv3) and is characterized by the following operation. That is, the normalized optimum recording pulse widths nv1, nv2 for at least two linear velocities (Lv1, Lv2) are calculated, and the normalized optimum recording pulse width nv3 for the third linear velocity is set as nv3=nv2. Then, the optimum recording power for the third linear velocity Lv3 is calculated depending on two of (Formulas 1), one (Formula 1) is a relational expression between the target recording power Pwt and the time width Tt of the recording pulse for the first linear velocity Lv1 and the other (Formula 1) is a relational expression between the target recording power Pwt and the time width Tt of the recording pulse for the second linear velocity Lv2.

The information recording method of an embodiment of the present invention mentioned above is characterized by the following operation. That is, by using the normalized optimum pulse width (nv1) for the first linear velocity Lv1 and the normalized optimum pulse width (nv2) for the second linear velocity Lv2, the optimum pulse width (nv3) normalized for the third linear velocity Lv3 is recorded using the time width of the recording pulse which is integer nv3 (nv3 satisfies “nv3=nv2>nv1”).

It is a characteristic of the information recording method of the invention that the optimum recording pulse width nv3 for the third linear velocity satisfies a condition of Tw/16×nv3≧2 [ns].

The optical information recording medium of an embodiment of the present invention is an optical information recording medium which is used with any method the information recording methods above mentioned and is characterized by the following constitutions. That is, the optical information recording medium is recorded at different linear velocities Lv1<Lv2<Lv3. And when the recommended pulse time width of the peak power level of the recording pulse sequence at the time of recording a shortest mark is expressed with Tt=n×Tw/16 (n is positive integer) and the recommended pulse value for the first linear velocity is expressed with n1 and the recommended pulse value for the second linear velocity is expressed with n2 and the recommended pulse value for the third linear velocity is expressed with n3, the three values of n1, n2 and n3 are recorded on the disc management area in advance.

It is a characteristic of the optical information recording medium of an embodiment of the invention that the recommended recording pulse value n3 for the third linear velocity satisfies a condition of Tw/16×n3≧2 [ns].

The optical information recording and reproducing apparatus of an embodiment of the present invention switches over and irradiates a laser light with plural of powers, and realizes recording on an optical information recording medium on which information is recorded as marks and spaces of plural lengths by using the optimum recording power and the condition of the optimum recording pulse sequence. And, the optical information recording and reproducing apparatus is characterized by the following constitutions. The optical information recording and reproducing apparatus comprises a modulation instrument, a recording pulse sequence conversion instrument, a laser drive instrument, a reproduced signal processing instrument and a recording condition calculation instrument. The modulation instrument generates a test pattern containing at least two recording mark lengths ML2, ML8 (Here, ML2<ML8). The recording pulse sequence conversion instrument converts to a recording pulse sequence which contains different two recording pulses WS1, WS2 (Here, the time width Tt1 of the peak power level of WS1 is different from the time width Tt2 of the peak power level of WS2) corresponding to the mark length ML2 and a recording pulse WS3 corresponding to the mark length ML8 depending on a signal of the test pattern. The laser drive instrument controls the laser power to the optical information recording medium, and records the test pattern to the optical information recording medium by plural recording powers while changing the recording power according to the recording pulse sequence. The reproduced signal processing instrument generates a reproduced signal from the optical information recording medium, and measures the first signal index and the second signal index from the reproduced signal. The recording condition calculation instrument decides the optimum recording power (Pwo) depending on the second signal index, and finds the target recording power depending on the first signal index, and finds the optimum time width Tto of the recording pulse of the recording mark length ML2 by calculation depending on the optimum power and the target recording power.

As described above, with the embodiment mentioned above, when high speed recording is performed to recordable optical disc medium for an example, by the effect of rising time and trailing time of the laser for changing the recording power, or an overshoot or the like, the recording power and the pulse time width are controlled precisely, and a method in which the optimum recording power and the time width of the recording pulse sequence for obtaining high signal quality are decided efficiently and precisely can be provided.

With the information recording method in the embodiment of the present invention, for an example, the high reliability of the recording/reproduction operation is obtained and the miniaturization of the optical information recording and producing apparatus is realized at the same time, so that the point of the cost is advantageous.

With the embodiment of the present invention, for an example, even when a data is recorded to an optical disc which has a test recording area only at the inner side of the optical disc by using the CAV method, a method in which the optimum recording power and the time width of the recording pulse sequence for obtaining high signal quality are decided efficiently and precisely can be provided.

### INDUSTRIAL APPLICABILITY

The information recording method, the optical information recording and reproducing apparatus, the optical information recording medium to be used therefore, the program and the recording medium according to the present invention have an effect that at least the time width of the recording pulse for obtaining high signal quality can be decided more precise than conventional, and is useful in digital household appliance, electric apparatus industry which includes information processing apparatus, or the like.

1. An information recording method of recording information on an optical information recording medium utilizing a desired recording power of a laser light and a desired time width of recording pulse, said information recording method comprising:
a test pattern generating step of generating a test pattern including a first recording mark length and a second recording mark length which is longer than said first recording mark length;
a recording pulse sequence converting step of converting said generated test pattern into a recording pulse sequence including test recording pulses, said test recording pulses corresponding to said first recording mark length and having a different time width to each other and a second test recording pulse corresponding to said second record mark length;
a recording step of recording said test pattern on a predetermined area of said optical information recording medium based on said recording pulse sequence, with changing a recording power sequentially by controlling said laser light;
a reproducing step of obtaining a first signal index every said test recording pulse having a different time width based on a reproduced signal obtained from said predetermined area, said first signal index corresponding to each said changed recording power, and of holding a relation between said obtained first signal index and said recording power, as a first signal index characteristic, and obtaining a second signal index according to each said recording power based on a portion corresponding to said second test recording pulse of said reproduced signal and holding a relation between said obtained second signal index and said recording power, as a second signal index characteristic; and
a processing step of obtaining said desired recording power to be used for a recording pulse corresponding to said first recording mark length based on said second signal index characteristic, and obtaining said desired time width of recording pulse corresponding to said first recording mark length, based on a predetermined rule by using (a) obtained said desired recording power, (b) each target recording power obtained from said first signal index characteristic which is held every said test recording pulse having a different time width by using a recommended first signal index and (c) each said different time width.

2. (canceled)

3. The information recording method according to claim 1, wherein
said first signal index is asymmetry or β-value of said reproduced signal;
said second signal index is a modulation level of said reproduced signal; and
in said reproducing step, when said first signal index is obtained every said test recording pulse having a different time width, a reproduced signal of each said test recording pulse having a different time width and a reproduced signal of said second test recording pulse are used.

4. The information recording method according to claim 1, wherein
said first signal index is a signal index which is obtained by using a reproduced signal level of said first recording mark length and a reproduced signal level of a reflected light at a non-recorded portion.

5. The information recording method according to claim 1, wherein
when Tt1 and Tt2 represent respective widths of said test recording pulses having different time widths and Pwt1 and Pwt2 represent respective said target recording powers, in said processing step, constants C1 and C2 are obtained by using that a following formula 1 is approved.
Pwt=C1/Tt+C2 (wherein, C1 and C2 are constants) [Formula 1]

6. The information recording method according to claim 5, wherein
said obtaining of said desired time width of recording pulse corresponding to said first recording mark length based on said predetermined rule means that T to is obtained by using a following formula 5 when said T t o represents said desired time width and P w o represents said desired recording power.
Tto=Tt1×Tt2×(Pwt1−Pwt2)/{Pwo×(Tt2−Tt1)−(Tt2×Pwt2−Tt1×Pwt1)} [Formula 5]

7. The information recording method according to claim 1, wherein
said test pattern includes a repeat signal of a mark and a space to be formed by controlling an irradiation of said laser corresponding to said first recording mark length and a repeat signal of a mark and a space to be formed by controlling an irradiation of said laser corresponding to said second recording mark length.

8. The information recording method according to claim 7, wherein
said first recording mark length is such recording mark length of a shortest length 2 T; and
said test pattern includes a repeat signal of a mark of 2 T and a space of 2 T and a repeat signal of a mark and a space, each of said mark and said space having at least one length of 5 T to 9 T for said second mark length.

9. The information recording method according to claim 7, wherein
said first recording mark length is a recording mark length of 3 T when 3 T represents a recording mark length of a shortest length; and
said test pattern includes a repeat signal of a mark of 3 T and a space of 3 T and a repeat signal of a mark and a space, each of said mark and said space having at least one length of 6 T to 14 T for said second mark length.

10. The information recording method according to claim 1, wherein
said test pattern is a random signal where frequency of occurrence of each said mark length is substantial constant.

11. The information recording method according to claim 1, wherein
said test pattern is an arbitrary random signal modulated with a 17PP modulation or a 8-16 modulation.

12. The information recording method according to claim 1, wherein
in said recording step, a plurality of said test patterns are continuously recorded while changing said recording power; and
in said reproducing step, said plurality of said test patterns are continuously reproduced.

13. The information recording method according to claim 1, wherein
when Tw represents a reference time width, a time width of said first recording mark length is normalized by a unit of integral multiple of Tw/16 .

14. An information recording method of recording information on an optical information recording medium with at least a first linear velocity Lv1, a second linear velocity Lv2 and a third linear velocity Lv3, said first, second and third linear velocities being different each other (wherein, Lv1<Lv2<Lv3), said information recording method comprising:
a step of obtaining values relating to at least normalized optimum recording pulse widths nv1 and nv2 at said first linear velocity Lv1 and said second linear velocity Lv2 as information corresponding to said desired time width, by using said information recording method according to claim 1;
a target recording power obtaining step of (a) obtaining a target recording power Pwt12 corresponding to said value relating to said normalized optimum recording pulse width nv2 by using a predetermined relation between a target recording power Pwt and a time width Tt of said recording pulse, at said first linear velocity Lv1, when said value relating to said normalized optimum recording pulse width nv2 is equal to or more than a predetermined reference value, and (b) obtaining a target recording power Pwt13 corresponding to a value relating to a normalized optimum recording pulse width nv3 at said third linear velocity by using a predetermined relation between a target recording power Pwt and a time width Tt of said recording pulse, at said first linear velocity Lv1 and further obtaining a target recording power Pwt23 corresponding to a value relating to said optimum recording pulse width nv3 by using a relation between a target recording power Pwt and a time width Tt of said recording pulse, at said second linear velocity Lv2, when said value relating to said normalized optimum recording pulse width nv2 is less than said predetermined reference value; and
an optimum recording power obtaining step of obtaining an optimum recording power at said third linear velocity Lv3 by using said obtained target recording power.

15. The information recording method according to claim 14, wherein
said time width Tt of said recording pulse is each time width Tt of test recording pulses which corresponds to said first recording mark length and has different time width to each other; and
said predetermined relation is a relation in which said each time width Tt of test recording pulses having different time width and a target recording power Pwt corresponding to said Tt satisfy a following formula 1.
Pwt=C1/Tt+C2 (wherein, C1 and C2 are constants) [Formula 1]

16. The information recording method according to claim 14, wherein
when said normalized optimum recording pulse width nv2 is equal to or more than said predetermined reference value, said normalized optimum pulse width nv3 at said third linear velocity Lv3 is determined as an integer nv3 satisfying a condition of nv3=nv2>nv1.

17. The information recording method according to claim 14, wherein
said optimum pulse width nv3 at said third linear velocity Lv3 satisfies a condition of Tw/16×nv3≧2 [ns].

18. The information recording method according to claim 14, wherein
a channel clock to be used when recording by said third linear velocity Lv3 is 330 MHz or more.

19. An optical information recording medium which is used by the information recording method according to claim 1, wherein
recording of information on said optical information recording medium is performed by using a first linear velocity Lv1, a second linear velocity Lv2 and a third linear velocity Lv3 (wherein, Lv1<Lv2<Lv3); and
when Tt=n×Tw/16 (wherein, n is a positive integer) represents a recommended pulse time width of peak power level of said recording pulse sequence at the time of recording a shortest mark, n1 represents a recommended pulse width at said first linear velocity, n2 represents a recommended pulse width at said second linear velocity and n3 represents a recommended pulse width at said third linear velocity, values of said n1, n2 and n3 are recorded in a disc management area of said optical information recording medium beforehand.

20. The optical information recording medium according to claim 19, wherein
said three recommended pulse widths satisfy a condition of n1=n2=n3.

21. The optical information recording medium according to claim 19, wherein
said three recommended pulse widths satisfy a condition of (n2/n1)=(n3/n2).

22. The optical information recording medium according to claim 19, wherein
said three recommended pulse widths satisfy a condition of n3=n2≧n1.

23. The optical information recording medium according to claim 19, wherein
a value n3 of said recommended pulse width of said third linear velocity satisfies a condition of Tw/16×n3≧2 [ns].

24. An optical information recording and reproducing apparatus which records information on an optical information recording medium utilizing a desired recording power of a laser light and a desired time width of recording pulse, said optical information recording and reproducing apparatus comprising:
a modulation unit which generates a test pattern including a first recording mark length and a second recording mark length which is longer than said first recording mark length;
a recording pulse sequence converting unit which converts said generated test pattern into a recording pulse sequence including test recording pulses, said test recording pulses corresponding to said first recording mark length and having a different time width to each other and a second test recording pulse corresponding to said second record mark length;
a light irradiation unit which records said test pattern on a predetermined area of said optical information recording medium based on said recording pulse sequence, with changing a recording power sequentially by controlling said laser light;
a reproduced signal processing unit which obtains a first signal index every said test recording pulse having different time width based on a reproduced signal obtained from said predetermined area, said first signal index corresponding to each said changed recording power, and holds a relation between said obtained first signal index and said recording power, as a first signal index characteristic, and obtains a second signal index according to each said recording power based on a portion corresponding to said second test recording pulse of said reproduced signal and holds a relation between said obtained second signal index and said recording power, as a second signal index characteristic; and
a recording condition obtaining unit which obtains said desired recording power to be used for a recording pulse corresponding to said first recording mark length based on said second signal index characteristic, and obtains said desired time width of recording pulse corresponding to said first recording mark length, based on a predetermined rule by using (a) obtained said desired recording power, (b) each target recording power obtained from said first signal index characteristic which is held every said test recording pulse having a different said time width by using a recommended first signal index and (c) each said different time width.

25. (canceled)

26. The optical information recording and reproducing apparatus according to claim 24, wherein
said first signal index is asymmetry or β-value of said reproduced signal;
said second signal index is a modulation level of said reproduced signal; and
said reproduced signal processing unit uses a reproduced signal of each said test recording pulse having a different time width and a reproduced signal of said second test recording pulse when said first signal index is obtained every said test recording pulse having a different time width.

27. The optical information recording and reproducing apparatus according to claim 24, wherein
said first signal index is a signal index which is obtained by using a reproduced signal level of said first recording mark length and a reproduced signal level of a reflected light at a non-recorded portion.

28. The optical information recording and reproducing apparatus according to claim 24, wherein
when Tt1 and Tt2 represent respective widths of said test recording pulses having different time widths and Pwt1 and Pwt2 represent respective said target recording powers, said recording condition obtaining unit obtains constants C1 and C2 by using that a following formula 1 is approved.
Pwt=C1/Tt+C2 (wherein, C1 and C2 are constants) [Formula 1]

29. The optical information recording and reproducing apparatus according to claim 28, wherein
said obtaining of said desired time width of recording pulse corresponding to said first recording mark length based on a predetermined rule means that Tto is obtained by using a following formula 5 when said Tto represents said desired time width and Pwo represents said desired recording power.
Tto=Tt1×Tt2×(Pwt1−Pwt2)/{Pwo×(Tt2−Tt1)−(Tt2×Pwt2−Tt1×Pwt1)} [Formula 5]

30. A program which causes a computer to execute, in the information recording method according to claim 1,
said processing step of obtaining said desired recording power to be used for a recording pulse corresponding to said first recording mark length based on said second signal index characteristic, and obtaining said desired time width of recording pulse corresponding to said first recording mark length, based on a predetermined rule by using (a) obtained said desired recording power, (b) each target recording power obtained from said first signal index characteristic which is held every said test recording pulse having a different time width by using a recommended first signal index and (c) each said different time width.

31. A program which causes a computer to execute, in the information recording method according to claim 14,
said target recording power obtaining step of (a) obtaining a target recording power Pwt12 corresponding to said value relating to said normalized optimum recording pulse width nv2 by using a predetermined relation between a target recording power at said first linear velocity Lv1 and a time width Tt of said recording pulse when said value relating to said normalized optimum recording pulse width nv2 is equal to or more than a predetermined reference value, and (b) obtaining a target recording power Pwt13 corresponding to a value relating to a normalized optimum recording pulse width nv3 at said third linear velocity by using a predetermined relation between a target recording power Pwt at said first linear velocity Lv1 and a time width Tt of said recording pulse and further obtaining a target recording power Pwt23 corresponding to a value relating to said optimum recording pulse width nv3 by using a relation between a target recording power at said second linear velocity Lv2 and said time width Tt of said recording pulse when said value relating to said normalized optimum recording pulse width nv2 is less than said predetermined reference value, and
to execute said optimum recording power obtaining step of obtaining an optimum recording power at said third linear velocity Lv3 by using said obtained target recording power.

32. A recording medium which records the program according to claim 30 and can be processed by a computer.

33. A recording medium which records the program according to claim 31 and can be processed by a computer.

34. An information recording method of recording information on an optical information recording medium with at least a first linear velocity Lv1, a second linear velocity Lv2 and a third linear velocity Lv3, said first, second and third linear velocities being different each other (wherein, Lv1<Lv2<Lv3), said information recording method comprising:
a step of obtaining values relating to at least normalized optimum recording pulse widths nv1 and nv2 at said first linear velocity Lv1 and said second linear velocity Lv2 as a desired time width of recording pulse;
a target recording power obtaining step of (a) obtaining a target recording power Pwt12 corresponding to said value relating to said normalized optimum recording pulse width nv2 by using a predetermined relation between a target recording power Pwt and a time width Tt of said recording pulse, at said first linear velocity Lv1, when said value relating to said normalized optimum recording pulse width nv2 is equal to or more than a predetermined reference value, and (b) obtaining a target recording power Pwt13 corresponding to a value relating to a normalized optimum recording pulse width nv3 at said third linear velocity by using a predetermined relation between a target recording power Pwt and a time width Tt of said recording pulse, at said first linear velocity Lv1 and further obtaining a target recording power Pwt23 corresponding to a value relating to said optimum recording pulse width nv3 by using a relation between a target recording power Pwt and a time width Tt of said recording pulse, at said second linear velocity Lv2, when said value relating to said normalized optimum recording pulse width nv2 is less than said predetermined reference value; and
an optimum recording power obtaining step of obtaining an optimum recording power at said third linear velocity Lv3 by using said obtained target recording power.

35. An optical information recording medium which is used by the information recording method according to claim 14, wherein
recording of information on said optical information recording medium is performed by using a first linear velocity Lv1, a second linear velocity Lv2 and a third linear velocity Lv3 (wherein, Lv1<Lv2<Lv3); and
when Tt=n×Tw/16 (wherein, n is a positive integer) represents a recommended pulse time width of peak power level of said recording pulse sequence at the time of recording a shortest mark, n1 represents a recommended pulse width at said first linear velocity, n2 represents a recommended pulse width at said second linear velocity and n3 represents a recommended pulse width at said third linear velocity, values of said n1, n2 and n3 are recorded in a disc management area of said optical information recording medium beforehand.

36. The optical information recording medium according to claim 35, wherein said three recommended pulse widths satisfy a condition of n1=n2=n3.

37. The optical information recording medium according to claim 35, wherein said three recommended pulse widths satisfy a condition of (n2/n1)=(n3/n2).

38. The optical information recording medium according to claim 35, wherein said three recommended pulse widths satisfy a condition of n3=n2≧n1.

39. The optical information recording medium according to claim 35, wherein
a value n3 of said recommended pulse width of said third linear velocity satisfies a condition of Tw/16×n3≧2 [ns].
